(19) United States
(12) Patent Application Publication
(10) Pub. No.: US 2025/0219296 A1
(43) Pub. Date: Jul. 3, 2025

(54) TRANSMISSION LINE, FEED NETWORK, AND ANTENNA APPARATUS

(71) Applicant: HUAWEI TECHNOLOGIES CO., LTD., Shenzhen (CN)

(72) Inventors: Minghua YIN, Dongguan (CN); Zhongwei PENG, Dongguan (CN); Junlang WU, Dongguan (CN); Wei HAO, Dongguan (CN); Wen WU, Shenzhen (CN)

(21) Appl. No.: 19/083,899

(22) Filed: Mar. 19, 2025

Related U.S. Application Data
(63) Continuation of application No. PCT/CN2023/118920, filed on Sep. 14, 2023.

(30) Foreign Application Priority Data
Sep. 20, 2022 (CN) 202211144650.4

(51) Int. Cl. H01Q 19/10; H01Q 9/28; H01Q 15/18

(52) U.S. Cl. CPC H01Q 19/106; H01Q 9/28; H01Q 15/18

(57) ABSTRACT

Embodiments of this application provide a transmission line, a feed network, and an antenna apparatus. The transmission line is used for a radio frequency device. The transmission line includes a reflector, an insulation support, and a transmission structure. The transmission structure includes at least two side walls. The transmission structure is disposed on a surface of the insulation support, an included angle between two adjacent side walls of the transmission structure is greater than zero, and different side walls of the transmission structure are located on different surfaces of the insulation support. At least one surface of the transmission structure is disposed opposite to a part of a structure of the reflector, and a gap exists between the at least one surface of the transmission structure and the reflector. The transmission line has a small signal loss and occupies a small space.

### CROSS-REFERENCE TO RELATED APPLICATIONS

This application is a continuation of International Application No. PCT/CN2023/118920, filed on Sep. 14, 2023, which claims priority to Chinese Patent Application No. 202211144650.4, filed on Sep. 20, 2022. The disclosures of the aforementioned applications are hereby incorporated by reference in their entireties.

### TECHNICAL FIELD

Embodiments of this application relate to the field of antenna technologies, and in particular, to a transmission line, a feed network, and an antenna apparatus.

### BACKGROUND

With the development of communication technologies, users have increasingly high requirements on a transmission speed and a transmission bandwidth of a network. To meet requirements of the users, the communication technologies gradually develop from 2G, 3G, and 4G to 5G. As an important component of mobile communication, a base station antenna also evolves with the development of the communication technologies 2G, 3G, 4G, and 5G. The base station antenna gradually evolves from initial single frequency and dual frequency to multi-frequency and massive multiple-input multiple-output (massive MIMO). Currently, a large-scale multiple-input multiple-output base station antenna is mostly used for a 5G antenna, and the base station antenna features a large-scale dense array. Generally, the base station array antenna includes a plurality of radiating elements and a plurality of feed networks, and each radiating element is electrically connected to a feed network corresponding to the radiating element, to enable the radiating element to receive or send a radio frequency signal through the feed network of the radiating element.

In a related technology, a feed network of an antenna includes a transmission line. The transmission line usually includes an insulation layer and a microstrip. The insulation layer is disposed on a bottom plate, and a gap exists between the insulation layer and the bottom plate. The microstrip is attached to a surface of the insulation layer. An end of the microstrip is electrically connected to a radio frequency signal port, and another end is electrically connected to radiating element, to enable the feed network to feed a radio frequency signal into the radiating element.

However, because a structure of the feed network is complex, a plurality of microstrips are disposed, and it is difficult to arrange the plurality of microstrips on a surface of an insulation layer with a small area. If the area of the insulation layer is increased, it does not facilitate miniaturization development of the antenna.

### SUMMARY

Embodiments of this application provide a transmission line, a feed network, and an antenna apparatus. The transmission line has a small energy loss and occupies a small space. This facilitates miniaturization development of a radio frequency device.

According to a first aspect, an embodiment of this application provides a transmission line, used for a radio frequency device, including a reflector, an insulation support, and a transmission structure. The transmission structure includes at least two side walls, the transmission structure is disposed on a surface of the insulation support, an included angle between two adjacent side walls of the transmission structure is greater than zero, and different side walls of the transmission structure are located on different surfaces of the insulation support. At least one side wall of the transmission structure is disposed opposite to at least one surface of the reflector, and a gap exists between the at least one side wall of the transmission structure and the reflector.

According to the transmission line in this embodiment of this application, the transmission structure is configured as a structure including at least two connected side walls. In this way, a volume of the insulation support connected to a surface of the transmission structure can be reduced. In other words, a volume of an air medium between the surface of the transmission structure and the reflector can be increased. Because both a dielectric constant and a dissipation factor of the air medium are less than those of the insulation support, when an area of the air medium between the transmission structure and the reflector is increased, a dielectric loss of a radio frequency signal in the transmission structure during transmission can be reduced.

In a possible implementation, the radio frequency device is an antenna apparatus, a filter, a power splitter, a combiner, or a phase shifter.

In a possible implementation, the transmission structure is of a straight-line structure; or the transmission structure is of a fold-line structure.

In a possible implementation, the transmission structure includes three side walls.

According to a second aspect, an embodiment of this application provides a feed network, used for an antenna apparatus and including at least one transmission line according to the first aspect.

According to the feed network in this embodiment of this application, a dielectric loss can be reduced by disposing the transmission line according to the first aspect.

In a possible implementation, there are a plurality of transmission lines, a part of the transmission lines are disposed vertically, and a part of the transmission lines are disposed horizontally.

The part of the transmission lines of the feed network are disposed vertically, and the part of the transmission lines of the feed network are disposed horizontally, so that a space occupied by the feed network in a same plane (for example, a horizontal plane or a vertical plane) can be reduced, and the entire feed network can be in a three-dimensional space, thereby reducing the space occupied by the feed network and facilitating assembly.

According to a third aspect, an embodiment of this application provides an antenna apparatus, including a radiating element and the transmission line according to the first aspect. A feed network is formed through connection of at least one transmission line. The transmission line includes a reflector, an insulation support, and a transmission circuit, and the transmission circuit includes a plurality of transmission structures. Both the transmission circuit and the radiating element are located on a surface of the insulation support, and the transmission circuit is electrically connected to the radiating element. The transmission circuit includes the plurality of transmission structures, a part of the plurality of transmission structures are disposed along a first direction, and a part of the transmission structures are disposed along a second direction. Each transmission structure includes at least two side walls, the insulation support is disposed on a first surface of the reflector, at least one side wall of each transmission structure is disposed opposite to a part of a structure of the reflector, and a gap exists between the at least one side wall of each transmission structure and the reflector. The first direction is a height direction of the antenna apparatus, and the second direction is a direction from a first end to a second end of the reflector.

According to the antenna apparatus provided in this embodiment of this application, the part of the transmission structures are disposed along the first direction, and the part of the transmission structures are disposed along the second direction. In this way, a size of the transmission structure on the insulation support in a two-dimensional plane (for example, a horizontal plane) can be reduced, so that the antenna structure may be a three-dimensional structure with a small volume. This facilitates miniaturization development of the antenna apparatus, and can further avoid a problem that the antenna apparatus occupies a large space in one of two-dimensional spaces, thereby saving an installation space and facilitating assembly.

One side wall of each transmission structure is disposed opposite to the part of the structure of the reflector, so that the part of the structure of the reflector may be used as a reference ground of the transmission line, and a radio frequency signal may be propagated along the transmission line after being introduced into the transmission line. In addition, the transmission structure is configured as a structure including at least two connected side walls, so that a volume of the insulation support connected to a surface of the transmission structure can be reduced. In other words, an area of an air medium between the surface of the transmission structure and the reflector can be increased. Because both a dielectric constant and a dissipation factor of the air medium are less than those of the insulation support, when the area of the air medium between the transmission structure and the reflector is increased, a dielectric loss of a radio frequency signal in the transmission structure during transmission can be reduced. The transmission circuit in this embodiment of this application is simple, so that a signal loss amount of the transmission circuit is reduced, and a size of the transmission circuit is also reduced, thereby reducing a space occupied by the transmission circuit in the antenna apparatus, and providing a proper space for disposing another component. In addition, the transmission circuit in this embodiment of this application is also simple to manufacture, thereby improving manufacturing efficiency of the antenna apparatus.

In an optional implementation, the radiating element includes at least one group of radiating portions, and the at least one group of radiating portions is distributed in an array in the second direction.

The radiating element is configured to include the at least one group of radiating portions, so that the antenna apparatus may have a plurality of groups of radiating portions, and the antenna apparatus may drive the plurality of groups of radiating portions through one transmission circuit, thereby improving utilization of the transmission circuit, simplifying a structure of the antenna apparatus, improving radiating efficiency and a radiating bandwidth of the antenna apparatus, and facilitating development of a large-scale dense array of the antenna apparatus.

In an optional implementation, a plurality of transmission structures include a primary transmission structure and a secondary transmission structure. A first end of each primary transmission structure is connected to one radio frequency signal port, and a second end of each primary transmission structure is electrically connected to at least one secondary transmission structure. An end that is of each secondary transmission structure and that is away from a second end of the primary transmission structure is electrically connected to one radiating portion.

One primary transmission structure is connected to the at least one secondary transmission structure, and each secondary transmission structure is electrically connected to one radiating portion, so that one primary transmission structure can feed a plurality of secondary transmission structures, and further feed a plurality of radiating portions. In this way, one primary transmission structure can drive the plurality of radiating portions. This can reduce a quantity of radio frequency signal ports, simplify a structure of the transmission circuit, further simplify a structure of the antenna apparatus, and reduce costs.

In an optional implementation, the primary transmission structure includes at least a first side wall and a second side wall. The first side wall is disposed opposite to the reflector, and a gap exists between the first side wall and the reflector. The first side wall is electrically connected to the secondary transmission structure. The second side wall is fixedly connected to at least a part of the first side wall, and an included angle between the second side wall and the first side wall is greater than zero. A length of the first side wall is greater than or equal to a length of the second side wall. The insulation support is provided with a through hole for installing the primary transmission structure, and an end that is of the second side wall and that is away from the first side wall extends along an inner wall of the through hole in a direction away from the first side wall.

The primary transmission structure is configured to include the first side wall and the second side wall, and the first side wall is disposed opposite to the reflector. In this way, a volume of the insulation support connected to a surface of the primary transmission structure can be reduced. In other words, an area of an air medium between the surface of the primary transmission structure and the reflector is increased. Because both a dielectric constant and a dissipation factor of the air medium are less than those of the insulation support, when the area of the air medium between the primary transmission structure and the reflector is increased, a dielectric loss of a radio frequency signal in the primary transmission structure during transmission can be reduced. The reflector is provided with the through hole, so that different side walls of the primary transmission structure may be located on different surfaces of the reflector, and an included angle between the different side walls of the primary transmission structure may be greater than zero.

In an optional implementation, the primary transmission structure further includes a third side wall. The third side wall is connected to the second side wall, and an end that is of the third side wall and that is away from the second side wall extends along a part of the surface of the insulation support around the through hole.

The third side wall is disposed, so that the area of the air medium between the surface of the primary transmission structure and the reflector may be further increased, and a dielectric loss of the primary transmission structure during energy transmission is reduced.

In an optional implementation, there is at least one through hole, and a part of the primary transmission structure is disposed in each through hole.

A plurality of through holes are provided, so that the primary transmission structure may be disposed at a plurality of positions, thereby improving design flexibility of the primary transmission structure.

In an optional implementation, each secondary transmission structure includes at least one transmission sub-structure. A transmission sub-structure close to the second end of the primary transmission structure is electrically connected to the primary transmission structure. A transmission sub-structure close to the radiating portion is electrically connected to the radiating portion. Adjacent transmission sub-structures are connected in series to each other.

The secondary transmission structure is configured as a structure including the at least one transmission sub-structure, so that structures of different secondary transmission structures may be different. For example, some secondary transmission structures have short lengths, and some secondary transmission structures have long lengths. In this way, when the different secondary transmission structures are disposed at different positions, all the different secondary transmission structures may be electrically connected to the primary transmission structure, and it is also ensured that a specific gap may exist between two adjacent radiating portions in the second direction, thereby preventing signal interference between adjacent radiating portions.

In an optional implementation, the transmission sub-structure includes at least a fourth side wall and a fifth side wall. The fourth side wall is disposed opposite to a part of the structure of the reflector, and a gap exists between the fourth side wall and the reflector. The fifth side wall is connected to the fourth side wall, and an included angle between the fourth side wall and the fifth side wall is greater than zero.

In an optional implementation, the transmission sub-structure further includes a sixth side wall. The sixth side wall is connected to the fifth side wall, an included angle between the fifth side wall and the sixth side wall is greater than zero, and both the fourth side wall and the sixth side wall are located on a surface on which the fifth side wall is connected to the insulation support.

The transmission sub-structure is configured to include the fourth side wall and the fifth side wall, and the fourth side wall is disposed opposite to the part of the structure of the reflector. In this way, a volume of the insulation support connected to a surface of the transmission structure can be reduced. In other words, an area of an air medium between the surface of the transmission sub-structure and the reflector is increased. Because both a dielectric constant and a dissipation factor of the air medium are less than those of the insulation support, when the area of the air medium between the transmission sub-structure and the reflector is increased, a dielectric loss of a radio frequency signal in the transmission structure during transmission can be reduced.

The sixth side wall is disposed, so that the area of the air medium between the surface of the transmission sub-structure and the reflector may be further increased, and a dielectric loss of the transmission sub-structure during energy transmission may be further reduced.

In an optional implementation, the transmission sub-structure is of a straight-line structure; or the transmission sub-structure is of a fold-line structure, the fold-line structure is provided with at least one raised part, and the at least one raised part is spaced apart along the first direction or the second direction.

The transmission sub-structure is configured as the straight-line structure, so that the transmission sub-structure is simple and convenient for production.

The transmission sub-structure is configured as the fold-line structure, so that a length of the transmission sub-structure may be increased without increasing sizes of the insulation support in the first direction and the second direction, thereby reducing wiring density and reducing inter-line coupling.

In an optional implementation, the transmission sub-structure includes at least one first transmission sub-structure. Each first transmission sub-structure is disposed on the surface of the insulation support along the first direction, and a part of side walls of each first transmission sub-structure is disposed opposite to the part of the structure of the reflector. A first end of each first transmission sub-structure is electrically connected to the radiating portion. A second end of the first transmission sub-structure is electrically connected to the second end of the primary transmission structure; or a second end of the first transmission sub-structure is electrically connected to another transmission sub-structure; or a second end of a part of the first transmission sub-structure is electrically connected to the second end of the primary transmission structure, and a second end of a part of the first transmission sub-structures is electrically connected to another transmission sub-structure.

The transmission sub-structure is disposed away from a structure including the first transmission sub-structure, and the first transmission sub-structure is disposed on the surface of the insulation support along the first direction. Compared with a related technology in which a microstrip is disposed on an insulation layer, in this embodiment of this application, a space of the insulation support in a horizontal direction occupied by the first transmission sub-structure can be reduced, and an area of the insulation support in the horizontal direction can be reduced. In other words, a small insulation support may be used to meet a layout requirement of the first transmission sub-structure, this facilitates miniaturization development of the antenna apparatus. In addition, because the first transmission sub-structure is disposed along the first direction, compared with a related technology in which a plurality of microstrips are disposed in parallel, in this embodiment of this application, a coupling effect between the first transmission sub-structure and another transmission structure can be reduced, thereby improving a directivity coefficient of the antenna apparatus and improving radiating efficiency of the antenna apparatus.

In an optional implementation, the transmission sub-structure further includes a second transmission sub-structure. The second transmission sub-structure is disposed on the surface of the insulation support along the second direction, and a part of side walls of the second transmission sub-structure is disposed opposite to the reflector. The second end of the first transmission sub-structure is electrically connected to a first end of the second transmission sub-structure, and a second end of the second transmission sub-structure is electrically connected to the second end of the primary transmission structure. An included angle between the first transmission sub-structure and the second transmission sub-structure is greater than zero.

The second transmission sub-structure is disposed, so that the first transmission sub-structure can be conveniently connected to the primary transmission structure. In addition, a length of the secondary transmission structure may be further increased by disposing the second transmission sub-structure. In this way, wiring density may be reduced, thereby reducing inter-line coupling.

In an optional implementation, the first transmission sub-structure is of a straight-line structure, the second transmission sub-structure is of a fold-line structure, the fold-line structure is provided with at least one raised part, and the at least one raised part is spaced apart along the second direction.

In an optional implementation, the transmission circuit includes a first transmission circuit and a second transmission circuit. The first transmission circuit includes a first primary transmission structure and at least one secondary transmission structure, a first end of the first primary transmission structure is connected to a first radio frequency signal port, and a second end of the first primary transmission structure is electrically connected to the at least one secondary transmission structure. The second transmission circuit includes a second primary transmission structure and at least one secondary transmission structure, a first end of the second primary transmission structure is connected to a second radio frequency signal port, and a second end of the second primary transmission structure is electrically connected to the at least one secondary transmission structure.

In an optional implementation, the reflector includes a bottom plate and a radiating plate. The bottom plate is located at a bottom end of the reflector, the radiating plate is fastened to a surface of the bottom plate, and the first surface of the reflector is a surface on which the bottom plate is connected to the radiating plate. In the first direction, an end of the radiating plate is located on the first surface, and another end extends in a direction away from the first surface. In the second direction, the radiating plate extends from a first end of the reflector to a second end of the reflector, and the radiating plate is located between a third end and a fourth end of the bottom plate. An included angle between the radiating plate and the bottom plate is a first included angle, and the first included angle is greater than zero.

The reflector is configured as a structure having the bottom plate and the radiating plate, an end of the radiating plate is located on a first surface of the bottom plate, and another end extends in a direction away from the first surface. An included angle between the radiating plate and the bottom plate is a first included angle, and the first included angle is greater than zero. In this way, the bottom plate of the reflector and the radiating plate may be located in a three-dimensional space. For example, a part of the reflector, that is, the radiating plate, is disposed on the bottom plate along the first direction. In this way, in a case in which a total area of the reflector is the same as that in a related technology, an area of a two-dimensional space in which the bottom plate of the reflector is located may be reduced in this embodiment of this application, so that a two-dimensional space (for example, a horizontal direction) occupied by an antenna structure can be reduced, thereby facilitating installation.

In an optional implementation, the insulation support includes a base and a support wall. The base is disposed opposite to the bottom plate, and in the first direction, an end of the support wall is located on a surface that is of the base and that is away from the bottom plate, and another end extends in a direction away from the base. At least one support wall is spaced apart along the second direction on the surface that is of the base and that is away from the bottom plate. The support wall is disposed along a third direction, a first end of the support wall is close to the third end of the bottom plate, and a second end of the support wall is close to the fourth end of the bottom plate. An included angle between the support wall and the base is a second included angle, and the second included angle is greater than zero. The third direction is a direction from the third end to the fourth end of the reflector.

The insulation support is configured to include the base and the support wall. In this way, a part of a structure of the insulation support may be disposed opposite to the reflector, so that a transmission structure disposed on the insulation support may be disposed opposite to the reflector, thereby ensuring that a radio frequency signal in the transmission structure may be propagated along the transmission structure. The included angle between the support wall and the base is set to be greater than zero. In this way, the support wall and the base of the insulation support may also be located in a three-dimensional space, so that an area occupied by the insulation support in a two-dimensional space (for example, a horizontal direction) can be reduced, and a volume of the antenna apparatus in the two-dimensional space can be reduced, thereby facilitating installation.

In an optional implementation, the first transmission sub-structure is disposed on a surface of the support wall, a fourth side wall of the first transmission sub-structure is disposed opposite to the radiating plate, the first end of the first transmission sub-structure is located at an end that is of the support wall and that is close to the base, and the second end of the first transmission sub-structure extends along the surface of the support wall in the direction away from the base. An included angle between the first transmission sub-structure and a plane on which the base is located is greater than zero. Each first transmission sub-structure corresponds to one radiating portion, and an end that is of the first transmission sub-structure and that is away from the base is electrically connected to the radiating portion.

In an optional implementation, the second transmission sub-structure is disposed on a surface of the base, and a fourth side wall of the second transmission sub-structure is disposed opposite to the radiating plate. An end that is of the first transmission sub-structure and that is close to the base is electrically connected to the first end of the second transmission sub-structure, and the second end of the second transmission sub-structure is electrically connected to the primary transmission structure. The included angle between the first transmission sub-structure and the second transmission sub-structure is greater than zero.

In an optional implementation, the base includes a first raised wall and a second raised wall. Both the first raised wall and the second raised wall are disposed along the second direction. The first raised wall is disposed opposite to the second raised wall, and a gap exists between the first raised wall and the second raised wall, to enable a first avoidance space to be formed between the first raised wall and the second raised wall. The first avoidance space is provided along the second direction, and the first avoidance space is located between the third end and the fourth end of the bottom plate. A part of a structure of the radiating plate is located in the first avoidance space, and gaps exist between the radiating plate and the first raised wall and between the radiating plate and the second raised wall. The second transmission sub-structure is disposed on a surface of the first raised wall or a surface of the second raised wall.

The first raised wall and the second raised wall are disposed, to provide an installation position for disposing the second transmission sub-structure. The first avoidance space is formed between the first raised wall and the second raised wall, to provide a disposing space for the radiating plate. In this way, it can be further ensured that a gap may exist between the radiating plate and the transmission structure, so that a part of side walls of the transmission structure may be disposed opposite to the radiating plate, to ensure that a radio frequency signal in the transmission structure can be propagated to the radiating element along the transmission structure.

In an optional implementation, both the first raised wall and the second raised wall are provided with a plurality of protrusions and recesses that are alternately arranged. The plurality of protrusions and recesses that are alternately arranged extend along the second direction. The second transmission sub-structure is disposed on surfaces of the first raised wall and the second raised wall, to enable the second transmission sub-structure to be of the fold-line structure. In the second direction, a length of the second transmission sub-structure is greater than a length of orthographic projection of the second transmission sub-structure in the first direction.

In an optional implementation, the support wall is provided with a second avoidance space, the second avoidance space is located between the first end and the second end of the support wall, and the first avoidance space is in communication with the second avoidance space. In the first direction, the second avoidance space extends, in the direction away from the base, from an end that is of the first avoidance space and that is away from the bottom plate. An included angle between the support wall and the radiating plate is a third included angle, and the third included angle is greater than zero. A part of the structure of the radiating plate is located in the second avoidance space, and a gap exists between the radiating plate and a surface that is of the support wall and that faces the second avoidance space.

The second avoidance space is disposed, so that a height of the radiating plate in a vertical direction (that is, the first direction) of the bottom plate is large, and the radiating plate has more space to place the first transmission sub-structure, to increase a length of the first transmission sub-structure, thereby increasing the length of the first transmission sub-structure, reducing wiring density, and reducing inter-line coupling.

In an optional implementation, each group of radiating portions includes a first radiating portion and a second radiating portion. Both the first radiating portion and the second radiating portion are disposed on the surface of the support wall, the first radiating portion is located between the first end of the support wall and the second avoidance space, and the second radiating portion is located between the second end of the support wall and the second avoidance space. In the third direction, the first transmission circuit and the second transmission circuit are respectively disposed on two sides of the radiating plate, the first transmission circuit is located between the radiating plate and the third end of the bottom plate, and the second transmission circuit is located between the radiating plate and the fourth end of the bottom plate. The first radiating portion is electrically connected to the first transmission circuit, and the second radiating portion is electrically connected to the second transmission circuit.

In an optional implementation, the first primary transmission structure is disposed on the surface of the base. The second end of the first primary transmission structure is electrically connected to the at least one secondary transmission structure, an end that is of each secondary transmission structure of the first primary transmission structure and that is away from the second end of the first primary transmission structure is electrically connected to a ground end of one first radiating portion, and an open end of the first radiating portion extends along the third direction in a direction away from the radiating plate. The second primary transmission structure is disposed on the surface of the base. The second end of the second primary transmission structure is electrically connected to the at least one secondary transmission structure, an end that is of each secondary transmission structure of the second primary transmission structure and that is away from the second end of the second primary transmission structure is electrically connected to a ground end of one second radiating portion, and an open end of the second radiating portion extends along the third direction in the direction away from the radiating plate.

In an optional implementation, the support wall is provided with a first mounting part, the first mounting part protrudes from the surface of the support wall in a first end close to the bottom plate or a second end close to the bottom plate, and a surface of the first mounting part is disposed opposite to the radiating plate. The first transmission sub-structure is disposed on a surface of the first mounting part, the fourth side wall of the first transmission sub-structure is located on a surface that is of the first mounting part and that is opposite to the radiating plate, a fifth side wall of the first transmission sub-structure is located on a surface that is of the first mounting part and that faces the first end or the second end of the bottom plate, and a sixth side wall of the first transmission sub-structure is located on a surface that is of the first mounting part and that is away from the radiating plate.

In an optional implementation, the radiating plate includes a first connection part, a second connection part, and a radiating part. The first connection part is located at an end that is of the radiating plate and that is close to the bottom plate, and the second connection part is located between the first connection part and the radiating part. The radiating part extends, along the second direction in a direction away from the second connection part, from an end that is of the second connection part and that is away from the first connection part. Each group of radiating portions further includes a third radiating portion, and the radiating part is the third radiating portion.

In an optional implementation, the first included angle is 90°, or the second included angle is 90°, or the third included angle is 90°.

In an optional implementation, the antenna apparatus is of an axisymmetric structure, and a symmetry axis of the antenna apparatus is a plane on which the radiating plate is located.

### BRIEF DESCRIPTION OF DRAWINGS

FIG. 1 is a diagram of a structure of a transmission line according to an embodiment of this application;

FIG. 2 is a diagram of a part of a structure of a transmission line according to an embodiment of this application;

FIG. 3 is a cross-sectional diagram of the structure in FIG. 2;

FIG. 4 is a diagram of distribution of an electric field generated by a microstrip in a related technology;

FIG. 5A is a diagram of a part of a structure of a transmission line according to an embodiment of this application;

FIG. 5B is a diagram of distribution of an electric field generated by the transmission structure in FIG. 5A;

FIG. 6 is a diagram of another structure of a transmission line according to an embodiment of this application;

FIG. 7 is a cross-sectional diagram of the structure in FIG. 6;

FIG. 8 is a diagram of another structure of a transmission line according to an embodiment of this application;

FIG. 9 is a cross-sectional diagram of the structure in FIG. 8;

FIG. 10 is a diagram of another structure of a transmission line according to an embodiment of this application;

FIG. 11 is a cross-sectional diagram of the structure in FIG. 10;

FIG. 12 is a diagram of a structure of an antenna system according to an embodiment of this application;

FIG. 13 is a diagram of a structure of an antenna apparatus according to an embodiment of this application;

FIG. 14 is a diagram of a frame structure of an antenna apparatus according to an embodiment of this application;

FIG. 15 is a structural exploded view of the antenna apparatus in FIG. 13;

FIG. 16 is a diagram of a transmission structure and a part of a structure of a radiating element of an antenna apparatus according to an embodiment of this application;

FIG. 17 is a diagram of a part of a structure of a primary transmission structure of an antenna apparatus according to an embodiment of this application;

FIG. 18 is a diagram of a part of a cross-sectional structure of a primary transmission structure of an antenna apparatus according to an embodiment of this application;

FIG. 19 is a diagram of a part of a structure of a primary transmission structure of an antenna apparatus according to an embodiment of this application;

FIG. 20 is a diagram of a part of a cross-sectional structure of a primary transmission structure of an antenna apparatus according to an embodiment of this application;

FIG. 21 is a diagram of a structure in which a first transmission sub-structure of an antenna apparatus is disposed on an insulation support according to an embodiment of this application;

FIG. 22 is a diagram of a structure in which a second transmission sub-structure of an antenna apparatus is disposed on an insulation support according to an embodiment of this application; and

FIG. 23 is a diagram of a structure of a first raised wall of an antenna apparatus according to an embodiment of this application.

### REFERENCE NUMERALS

1000: Antenna system; 100: Antenna apparatus; 200: Fastening support; 300: Pole;
400: Grounding apparatus; 110: Radiating element; 111: Radiating portion; 1111: First radiating portion;
1112: Second radiating portion; 120: Transmission line; 121: Insulation support; 1211: Base;
1212: Support wall; 1213: First avoidance space; 1214: Second avoidance space; 1215: First raised wall;
1216: Second raised wall; 1217: First mounting part; 1218: Through hole; 1219: Hole-shaped structure;
122: Transmission circuit; 122a: First transmission circuit; 122b: Second transmission circuit;
1221: Transmission structure; 1221a, 1221b, and 1221c: Side wall; 1222: Primary transmission structure;
1222a: First side wall; 1222b: Second side wall; 1222c: Third side wall;
12221: First primary transmission structure; 12221a: First end of the first primary transmission structure;
12221b: Second end of the first primary transmission structure; 1223: Secondary transmission structure; 1223a: Fourth side wall;
1223b: Fifth side wall; 1223c: Sixth side wall; 12231: First secondary transmission structure; 12232: Second secondary transmission structure;
12233: Third secondary transmission structure; 12214: First transmission sub-structure; 12214a: First end of the first transmission sub-structure;
12214b: Second end of the first transmission sub-structure; 12215: Second transmission sub-structure; 12215a: First end of the second transmission sub-structure;
12215b: Second end of the second transmission sub-structure; 12222: Second primary transmission structure; 130: Reflector;
130a: First end of the reflector; 130b: Second end of the reflector; 130c: Third end of the reflector;
130d: Fourth end of the reflector; 131: Bottom plate; 132: Radiating plate; 1321: First connection part;
1322: Second connection part; 1323: Radiating part; 133: First surface; 134: Second surface;
140: Phase shifter; 150: Filter; 160: Calibration network; 170: Combiner; 180: Feed network;
1: Insulation layer; 2: Microstrip; 3: Bottom plate.

### DESCRIPTION OF EMBODIMENTS

Terms used in implementations of this application are only used to explain specific embodiments of this application, but are not intended to limit this application.

Unless otherwise specified in the context, in the entire specification and claims, a term “comprise (comprise)” and other forms of the term, for example, a third person singular form “comprises (comprises)” and a present participle form “comprising (comprising)” are interpreted as “open and inclusive”, that is, “include, but not limited to”. In descriptions of the specification, terms such as “one embodiment (one embodiment)”, “some embodiments (some embodiments)”, “exemplary embodiments (exemplary embodiments)”, “example (example)”, or “some examples (some examples)” are intended to indicate that specific features, structures, materials, or features related to embodiments or examples are included in at least one embodiment or example of the present disclosure. The foregoing schematic representations of the terms do not necessarily refer to a same embodiment or example. Further, the particular feature, structure, material, or characteristic may be included in any one or more embodiments or examples in any appropriate manner.

In addition, in this application, position terms such as “front” and “back” are defined relative to illustrative positions of components in accompanying drawings. It should be understood that these direction terms are relative concepts and are used for descriptions and clarification of “relative to”, and may vary based on changes of the positions of the components in the accompanying drawings.

The term “and/or” in embodiments of this application describes only an association relationship for describing associated objects and represents that three relationships may exist. For example, A and/or B may represent the following three cases: Only A exists, both A and B exist, and only B exists. In addition, the character “/” in this specification generally indicates an “or” relationship between the associated objects.

According to a first aspect, an embodiment of this application provides a transmission line 120. The transmission line 120 may be used for a radio frequency device. For example, the radio frequency device may be an antenna apparatus, a filter, a power splitter, a combiner, a phase shifter, or the like.

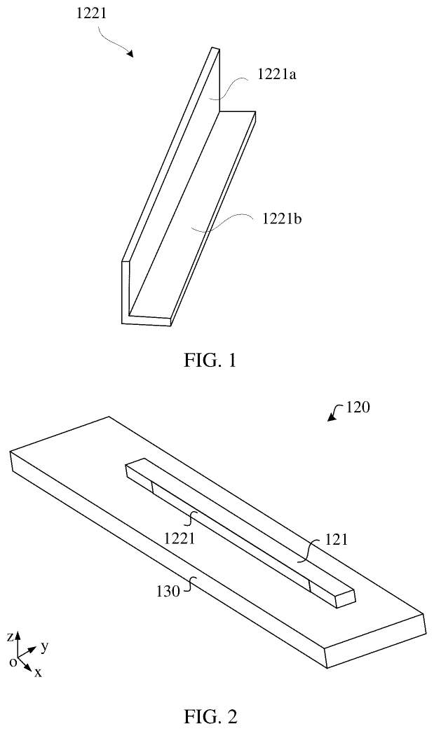

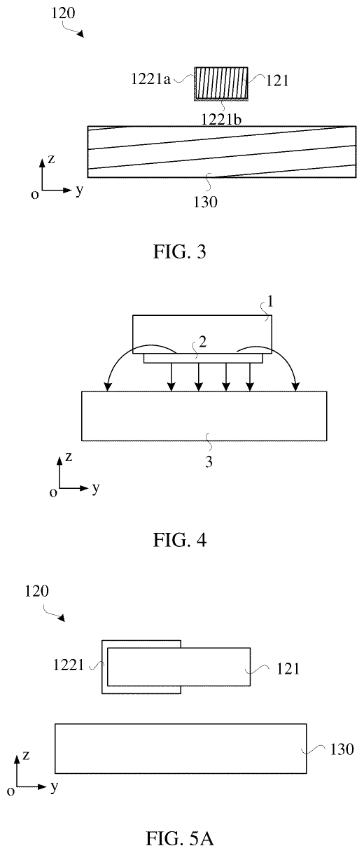

In some embodiments, as shown in FIG. 1, FIG. 2, and FIG. 3, the transmission line 120 may include a reflector 130, an insulation support 121, and a transmission structure 1221. The transmission structure 1221 may include two side walls: a side wall 1221a and a side wall 1221b. The transmission structure 1221 is disposed on a surface of the insulation support 121, and an included angle between the side wall 1221a and the side wall 1221b of the transmission structure 1221 is greater than zero. For example, the included angle between the side wall 1221a and the side wall 1221b of the transmission structure 1221 is 90°, and different side walls of the transmission structure 1221 are located on different surfaces of the insulation support 121. The side wall 1221b of the transmission structure 1221 is disposed opposite to a part of a structure of the reflector 130, and a gap exists between the side wall 1221b of the transmission structure 1221 and the reflector 130.

According to the transmission line in this embodiment of this application, the transmission structure is configured as a structure including at least two connected side walls. In this way, a volume of the insulation support connected to a surface of the transmission structure can be reduced. In other words, a volume of an air medium between the surface of the transmission structure and the reflector can be increased. Because both a dielectric constant and a dissipation factor of the air medium are less than those of the insulation support, when the area of the air medium between the transmission structure and the reflector is increased, a dielectric loss of a radio frequency signal in the transmission structure during transmission can be reduced.

For example, there may be two, three, four, five, or more side walls of each transmission structure 1221. In this embodiment of this application, a quantity of side walls of each transmission structure 1221 is not further limited.

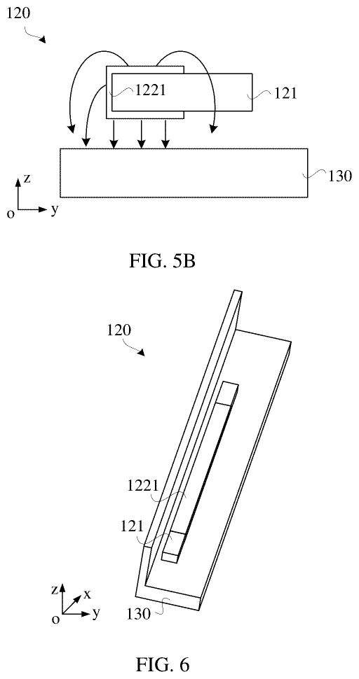

As shown in FIG. 4, a microstrip 2 is attached to a surface of an insulation layer 1 and is disposed opposite to a bottom plate 3. The microstrip 2 has only one side wall. When the microstrip 2 is disposed opposite to a bottom plate 131, an electric field is generated after a radio frequency signal is introduced into the microstrip 2 (where lines with arrows in FIG. 4 and FIG. 5B represent electric field lines). Because the microstrip 2 is completely attached to the insulation layer 1, electric field lines of the electric field generated by the microstrip 2 can be transferred to the bottom plate 3 after passing through the insulation layer 1, to be specific, the electric field lines can transfer a capability to the bottom plate 3 only after passing through the insulation layer 1. Because the insulation layer 1 has a dissipation factor and a dielectric constant, these factors increase a dielectric loss during energy transmission.

As shown in FIG. 5A and FIG. 5B, the transmission structure 1221 may include three side walls. One of the three side walls of the transmission structure 1221 is disposed opposite to the reflector 130. Because the three side walls of the transmission structure 1221 are disposed at an included angle, the three side walls of the transmission structure 1221 share a part of the insulation support 121. That is, a volume of the insulation support 121 connected to a surface of the transmission structure 1221 is reduced by disposing the three side walls. In other words, an area of an air medium between the surface of the transmission structure 1221 and the reflector 130 can be increased, that is, a quantity of electric field lines that are generated by the transmission structure 1221 and that pass through the insulation support 121 is reduced. Because both a dielectric constant and a dissipation factor of the air medium are less than those of the insulation support 121, when the area of the air medium between the transmission structure 1221 and the reflector 130 is increased, a dielectric loss in the transmission structure 1221 during energy transmission can be reduced.

It may be understood that the transmission line 120 provided in this embodiment of this application may be disposed on different radio frequency devices, and the reflector 130 may have a plurality of shapes. The following describes several embodiments in which the reflector 130 has different structures.

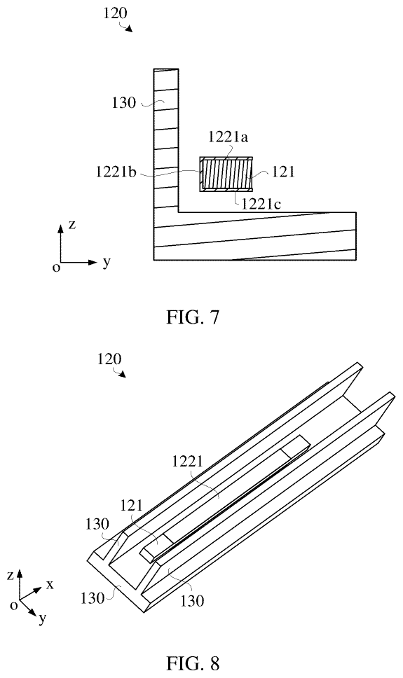

As shown in FIG. 6 and FIG. 7, the reflector 130 includes two plate structures disposed at an included angle, and the transmission structure 1221 includes three side walls, namely, the side wall 1221a, the side wall 1221b, and a side wall 1221c. The side wall 1221b is disposed between the side wall 1221a and the side wall 1221c. The side wall 1221a, the side wall 1221b, and the side wall 1221c of the transmission structure 1221 are attached to three surfaces of the insulation support 121. The side wall 1221a is disposed away from the side wall 1221c, the side wall 1221b and the side wall 1221c are respectively disposed opposite to the two plate structures of the reflector 130, and gaps exist between the side wall 1221b as well as the side wall 1221c and the two plate structures of the reflector 130.

In this embodiment, both the side wall 1221b and the side wall 1221c are disposed opposite to the reflector 130, so that an opposite area between the transmission structure 1221 and the reflector 130 can be increased, thereby improving coupling efficiency between the transmission structure 1221 and the reflector 130. In addition, because air media exist between the side wall 1221b and the reflector, and between the side wall 1221c and the reflector, and the side wall 1221a is disposed away from the side wall 1221c, the side wall 1221a and the side wall 1221c may share a part of the insulation support 121. That is, compared with a related technology, a volume of the insulation support 121 connected to the transmission structure 1221 is reduced, in other words, an area of the air medium between the transmission structure 1221 and the reflector 130 is increased. Because both a dielectric constant and a dissipation factor of the air medium are less than those of the insulation support 121, when the area of the air medium between the transmission structure 1221 and the reflector 130 is increased, a dielectric loss of a radio frequency signal in the transmission structure 1221 during transmission can be reduced.

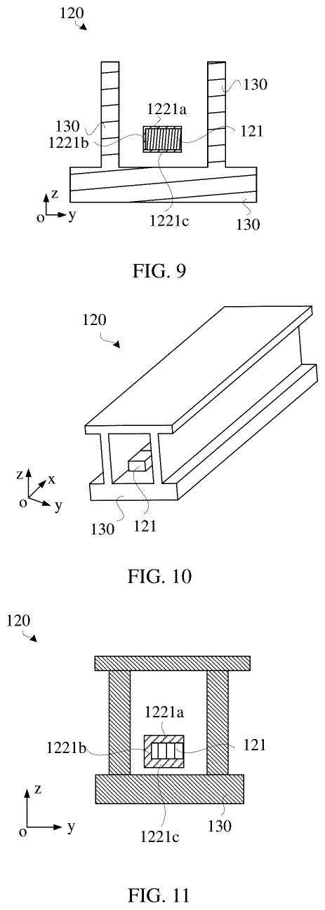

It may be understood that shapes of the reflector 130 and the insulation support 121 include but are not limited to the structures in the foregoing embodiments. In some embodiments, the structure of the reflector 130 may be in another form. As shown in FIG. 8 and FIG. 9, the reflector 130 includes three plate structures. One plate structure is disposed along an x direction, the other two plate structures are disposed along a z direction on the plate structure disposed along the x direction, and the two plate structures are oppositely disposed along the z direction. In addition, a gap exists between the two plate structures disposed along the z direction, a part of the insulation support 121 is disposed in the gap between the two plate structures disposed along the z direction, and the transmission structure 1221 is attached to a surface of the insulation support 121.

The transmission structure 1221 may include three side walls, namely, the side wall 1221a, the side wall 1221b, and the side wall 1221c. The side wall 1221b is disposed between the side wall 1221a and the side wall 1221c. The side wall 1221a, the side wall 1221b, and the side wall 1221c of the transmission structure 1221 are attached to three surfaces of the insulation support 121. The side wall 1221a is disposed away from the side wall 1221c. The side wall 1221b is disposed opposite to one of the plate structures disposed along the z direction. Certainly, in some other embodiments, the side wall 1221b may alternatively be disposed opposite to the other plate structure disposed along the z direction, and a gap exists between the side wall 1221b and the one of the plate structures disposed along the z direction. The side wall 1221c is disposed opposite to the plate structure disposed along the x direction, and a gap exists between the side wall 1221c and the plate structure disposed along the x direction. Technical effects in embodiments of this application are similar to those in FIG. 6 and FIG. 7. Therefore, the technical effects in embodiments of this application are not repeatedly described herein.

In some other embodiments, the structure of the reflector 130 may alternatively be a structure including four side walls. As shown in FIG. 10 and FIG. 11, the four side walls of the reflector 130 enclose a quadrilateral, a part of a structure of the insulation support 121 is disposed in a quadrilateral cavity formed by the four side walls, the transmission structure 1221 is disposed on a part of the insulation support 121 in the cavity, and the transmission structure 1221 has three side walls, namely, the side wall 1221a, the side wall 1221b, and the side wall 1221c. All the side wall 1221a, the side wall 1221b, and the side wall 1221c are disposed opposite to the reflector 130, so that an opposite area between the transmission structure 1221 and the reflector 130 is increased, thereby improving coupling efficiency between the transmission structure 1221 and the reflector 130.

In addition, because the side wall 1221a is disposed away from the side wall 1221c, the side wall 1221a and the side wall 1221c may share a part of the insulation support 121. That is, compared with a related technology, a volume of the insulation support 121 connected to the transmission structure 1221 is reduced, in other words, an area of an air medium between the transmission structure 1221 and the reflector 130 is increased. Because both a dielectric constant and a dissipation factor of the air medium are less than those of the insulation support 121, when the area of the air medium between the transmission structure 1221 and the reflector 130 is increased, a dielectric loss of a radio frequency signal in the transmission structure 1221 during transmission can be reduced.

In the foregoing embodiment, only a transmission line of a straight-line structure is described. Certainly, in some embodiments, the transmission line may be configured as a structure of another shape, or the transmission structure may be configured as a fold-line structure (as shown in FIG. 22).

Certainly, in some other embodiments, the reflector may alternatively be disposed in a structure of another form, which is not described one by one in this embodiment. The at least two side walls are disposed, a volume of the insulation support connected to the transmission structure can be reduced, that is, an area of an air medium between the transmission structure and the reflector is increased. Because both a dielectric constant and a dissipation factor of the air medium are less than those of the insulation support, when the area of the air medium between the transmission structure and the reflector is increased, a dielectric loss of a radio frequency signal in the transmission structure during transmission can be reduced. In other words, a dielectric loss of the transmission line provided in embodiments of this application is small.

The transmission line in embodiments of this application may be used for a radio frequency device. For example, the radio frequency device may be an antenna apparatus, a filter, a power splitter, a combiner, a phase shifter, or the like. For example, the transmission line may be used for a feed network of the antenna apparatus.

According to a second aspect, an embodiment of this application provides a feed network, used for an antenna apparatus and including at least one transmission line according to the first aspect.

According to the feed network in this embodiment of this application, a dielectric loss can be reduced by disposing the transmission line according to the first aspect.

In a possible implementation, there are a plurality of transmission lines, a part of the transmission lines are disposed vertically, and a part of the transmission lines are disposed horizontally. The part of the transmission lines of the feed network are disposed vertically, and the part of the transmission lines of the feed network are disposed horizontally, so that a space occupied by the feed network in a same plane (for example, a horizontal plane or a vertical plane) can be reduced, and the entire feed network can be in a three-dimensional space, thereby reducing the space occupied by the feed network and facilitating assembly. Certainly, in another embodiment, the feed network may alternatively be configured as another structure.

According to a third aspect, an embodiment of this application provides an antenna apparatus. The antenna apparatus uses the transmission line provided in the first aspect, and therefore has all technical effects brought by the transmission line. The antenna apparatus may be used for a communication base station, for example, a public mobile communication base station. The communication base station is an interface device for a mobile device to access the Internet, and is also a form of a radio station. In specific radio coverage, a radio transceiver station transmits information between the mobile device and the communication base station, that is, a mobile communication switching center.

In this embodiment, an example in which the antenna apparatus is used for a communication base station is used for description.

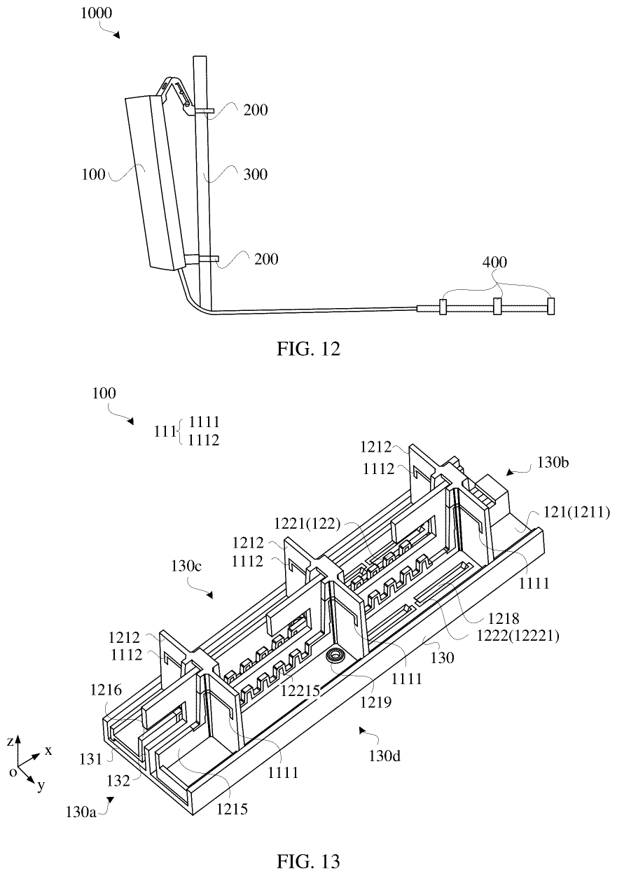

A main component for information transmission between the communication base station and the mobile device is an antenna system 1000. Generally, as shown in FIG. 12, the antenna system 1000 includes an antenna apparatus 100, a fastening support 200, a pole 300, a grounding apparatus 400, and the like. The antenna apparatus 100 is fastened on the pole 300 through the fastening support 200. During actual application, a position and an installation angle of the antenna apparatus 100 on the pole 300 may be adjusted by adjusting a position and an angle of the fastening support 200.

In addition, an end of the antenna apparatus 100 may be further connected to the grounding apparatus 400 through a connector, to ensure that the antenna apparatus 100 is grounded. A connector sealing piece is separately disposed at one end that is of the connector and that is connected to the antenna apparatus 100 and the other end that is of the connector and that is connected to the grounding apparatus 400, to ensure connection sealing between the two ends of the connector and the antenna apparatus 100 as well as the grounding apparatus 400. It may be understood that the connector sealing piece may be an insulation sealing tape, for example, a polyvinyl chloride (PVC) insulation tape.

During specific application, the antenna system 1000 is usually located in a radome. The radome is a structural piece that protects the antenna system 1000 from being affected by an external environment. The radome has a good electromagnetic wave penetration characteristic in terms of electrical performance, and can withstand an effect of an external harsh environment in terms of mechanical performance. The antenna system 1000 is protected through the radome, to prevent the antenna system 1000 from being damaged due to dust or water.

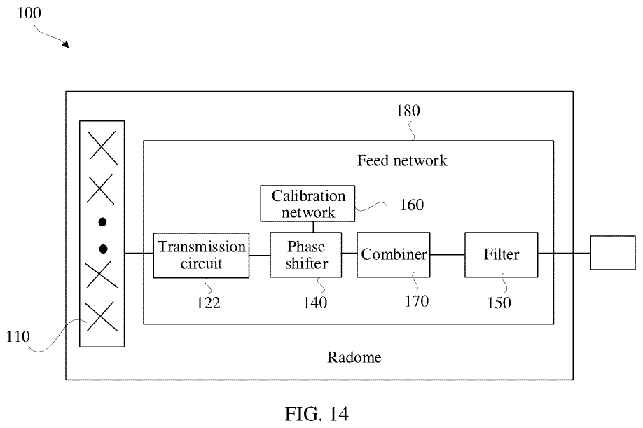

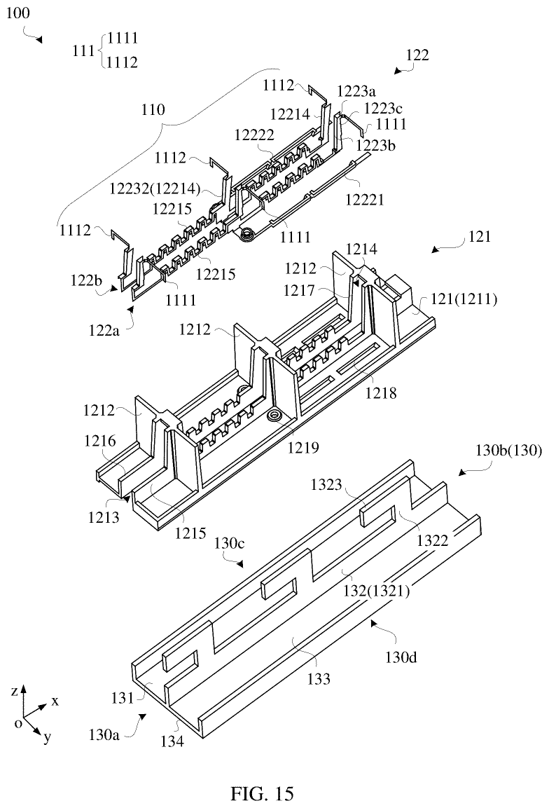

FIG. 13 is a diagram of a structure of an antenna apparatus according to an embodiment of this application. FIG. 14 is a diagram of a frame structure of an antenna apparatus according to an embodiment of this application. FIG. 15 is a structural exploded view of the antenna apparatus in FIG. 13. Refer to FIG. 13, FIG. 14, and FIG. 15. The antenna apparatus 100 in this embodiment of this application includes a radiating element 110 and a transmission line (not shown in the figure). The transmission line may include a reflector 130, an insulation support 121, and a transmission circuit 122. The transmission circuit 122 includes a plurality of transmission structures. The transmission circuit 122, the reflector 130, and the insulation support 121 jointly form a feed network (not shown in the figure) of the antenna apparatus. In other words, the feed network is equivalent to a plurality of transmission lines that are electrically connected to each other. In some embodiments, a transmission line is a feed network.

The feed network feeds a radio frequency signal to the radiating element 110 based on a specific amplitude and phase, or sends a received radio signal to a radio frequency device such as a signal processing unit of a communication base station based on a specific amplitude and phase.

Specifically, the transmission circuit 122 is disposed on the feed network. The transmission circuit 122 includes a plurality of transmission structures 1221. One end of the transmission circuit 122 is electrically connected to the radiating element 110, and the other end of the transmission circuit 122 is electrically connected to a radio frequency circuit (not shown in the figure), so that a radio frequency signal is transmitted between the radiating element 110 and the radio frequency circuit. For example, the other end of the transmission circuit 122 is electrically connected to a radio frequency signal port in the radio frequency circuit.

When the antenna apparatus 100 is a transmit antenna, the radio frequency circuit may provide a signal source for the antenna apparatus 100. For example, the other end of the transmission circuit 122 may be electrically connected to the radio frequency signal port in the radio frequency circuit, so that the radio frequency signal port sends a radio frequency signal, and feeds the radio frequency signal into the radiating element 110 in a form of a current. Then, the radiating element 110 sends the radio frequency signal in a form of an electromagnetic wave to the outside, and the radio frequency signal is received by a receive antenna in a mobile device.

When the antenna apparatus 100 is a receive antenna, the radio frequency circuit may receive a radio frequency signal fed back by the antenna apparatus 100. For example, the radiating element 110 of the antenna apparatus 100 converts a received electromagnetic wave signal into a current signal, and then transmits the current signal to the radio frequency circuit through the transmission circuit 122 in the feed network, and then a signal processing unit performs subsequent processing.

The radio frequency circuit includes a remote radio unit (RRU), that is, the remote radio unit is a part of the radio frequency circuit, and the radio frequency signal port is usually disposed in the remote radio unit. For specific circuit disposing and a working principle of the radio frequency circuit, directly refer to related content in a conventional technology. Details are not described herein.

During actual application, with wide application and development of a 5G technology, a base station antenna develops toward multi-band and multi-array, and integrity of the antenna apparatus 100 is increasingly high. For example, the antenna apparatus 100 may include a plurality of radiating elements 110 and a plurality of feed networks, and the feed networks and the radiating elements 110 are disposed in one-to-one correspondence, so that the antenna apparatus 100 forms an array antenna. Each radiating element 110 is electrically connected to a feed network corresponding to the radiating element 110, so that each radiating element 110 is electrically connected to the radio frequency circuit through the respective feed network, and each radiating element 110 receives or sends a radio frequency signal.

Refer to FIG. 13 and FIG. 15, the antenna apparatus 100 includes a reflector 130, an insulation support 121, and a transmission circuit 122. Both the transmission circuit 122 and the radiating element 110 are located on a same side of the reflector 130. For example, both the transmission circuit 122 and the radiating element 110 are located on a side that is of the reflector 130 and that is upward along a z direction. In this way, receiving sensitivity of the antenna apparatus 100 to an electromagnetic wave signal may be improved. For example, the electromagnetic wave signal may be aggregated on the radiating element 110 of the receive antenna through the reflector 130, so that a receiving or transmitting capability of the antenna apparatus 100 may be enhanced. In addition, interference of another electromagnetic wave from back (in an opposite direction) of the reflector 130 to a received signal may be blocked or shielded.

The reflector of the antenna apparatus and the reflector of the transmission line may be of a same structure, and the insulation support of the antenna apparatus and the insulation support of the transmission line may be of a same structure.

When the antenna apparatus 100 is an array antenna, the plurality of radiating elements 110 are spaced apart on the reflector 130 in an array, that is, an antenna array is formed on the reflector 130. A specific arrangement manner of the plurality of radiating elements 110 is not further limited in this embodiment of this application.

For ease of description, in this embodiment of this application, a first direction is a height direction of the antenna apparatus 100, and is a z direction. A second direction is a length direction of the antenna apparatus 100, and is an x direction, that is, a direction from a first end 130a of the reflector to a second end 130b of the reflector. A third direction is a width direction of the antenna apparatus 100, and is a y direction, that is, a direction from a third end 130c of the reflector to a fourth end 130d of the reflector. It may be understood that, the length direction of the reflector 130 and the insulation support 121 is consistent with the x direction, the width direction of the reflector 130 and the insulation support 121 is consistent with the y direction, and the height direction of the reflector 130 and the insulation support 121 is consistent with the z direction.

Refer to FIG. 15. Both the transmission circuit 122 and the radiating element 110 are located on a surface of the insulation support 121, and the transmission circuit 122 is electrically connected to the radiating element 110. The transmission circuit 122 includes a plurality of transmission structures 1221. In the transmission structures 1221, a part of the transmission structures 1221 are disposed along a z direction, and a part of the transmission structures 1221 are disposed along an x direction. Each transmission structure 1221 includes at least two side walls, an included angle between the two adjacent side walls of the transmission structure 1221 is greater than zero, and different side walls of the transmission structure 1221 are located on different surfaces of the insulation support 121. The insulation support 121 is disposed on a first surface 133 of the reflector 130, and a side wall of each transmission structure 1221 is disposed opposite to a part of a structure of the reflector 130, and a gap exists between the side wall of the transmission structure 1221 and the reflector 130.

In this embodiment, a surface of the insulation support refers to a surface on which the insulation support is exposed to the outside and is in contact with the air, and different surfaces of the insulation support refer to surfaces that are not coplanar on the insulation support. A surface of the reflector refers to a surface on which the reflector is exposed to the outside and is in contact with the air. Different surfaces of the reflector refer to surfaces that are not coplanar on the reflector.

During actual application, as shown in FIG. 14, the feed network 180 may further include a phase shifter 140 connected to the transmission circuit 122. The phase shifter 140 is configured to implement real-time change of network coverage, and adjust a signal phase to implement electrical downtilt of the array antenna. The phase shifter 140 may be connected to a calibration network 160, to obtain a calibration signal required by the antenna apparatus 100. In addition, the feed network 180 may further include a module configured to extend performance, such as a filter 150 and a combiner 170. The phase shifter 140, the filter 150, the calibration network 160, and the combiner 170 are not specifically described in this embodiment of this application. For details, refer to related content in a conventional technology.

In an optional implementation, the radiating element 110 includes at least one group of radiating portions 111. The at least one group of radiating portions 111 is distributed in an array in the x direction. For example, the radiating element 110 includes three groups of radiating portions 111, so that the antenna apparatus 100 may be a one-to-three drive unit. For example, in this embodiment, the three groups of radiating portions 111 may include three pairs of symmetrically disposed radiating arms, and a part of a structure of a radiating plate 132 located between a same pair of radiating arms, for example, a radiating part 1323 of the radiating plate 132.

The radiating element 110 is configured to include at least one group of radiating portions 111, so that the antenna apparatus 100 may have a plurality of groups of radiating portions 111, and the antenna apparatus 100 may drive the plurality of groups of radiating portions 111 through one feed network 180, thereby improving utilization of the feed network 180, simplifying a structure of the antenna apparatus 100, improving radiating efficiency and a radiating bandwidth of the antenna apparatus 100, and facilitating development of a large-scale dense array of the antenna apparatus 100.

A group of radiating portions 111 of the radiating element 110 may specifically include a pair of symmetric radiating portions 111, for example, two symmetric radiating arms, and further include a third radiating portion (a radiating part 1323 of the radiating plate 132, as shown in FIG. 15) located between the two symmetric radiating arms. A group of radiating portions 111 may be a first radiating portion 1111, a second radiating portion 1112, and the third radiating portion, and the third radiating portion is the radiating part 1323 (as shown in FIG. 15). The transmission circuit 122 is electrically connected to the first radiating portion 1111 and the second radiating portion 1112. After a radio frequency signal is introduced into the transmission circuit 122, a radio frequency signal may be fed into both the first radiating portion 1111 and the second radiating portion 1112. Because the transmission circuit 122 is disposed opposite to the reflector 130, the third radiating portion may generate a coupled radio frequency signal.

It should be noted that the antenna apparatus 100 in this embodiment of this application may include but is not limited to a dipole antenna, a patch antenna, a monopole antenna, or the like.

As shown in FIG. 13, for example, the antenna apparatus 100 may be an oscillator antenna. For ease of description, an example in which the radiating elements 110 of the antenna apparatus 100 may include three groups of radiating portions 111 spaced apart in an array along an x direction is used for description. Each group of radiating portions 111 includes the first radiating portion 1111, the second radiating portion 1112, and the third radiating portion. For example, structures of both the first radiating portion 1111 and the second radiating portion 1112 may be radiating arms.

It may be understood that, when the antenna apparatus 100 is a dual-polarized dipole antenna, there are two radio frequency signal ports in the radio frequency circuit, namely, a first radio frequency signal port and a second radio frequency signal port (not shown in the figure). Two transmission circuits 122 are respectively a first transmission circuit 122a and a second transmission circuit 122b. One end of the first transmission circuit 122a is electrically connected to the first radio frequency signal port, and the other end of the first transmission circuit 122a is electrically connected to at least one first radiating portion 1111. In this way, a first radio frequency signal may be transmitted to the first radiating portion 1111 through the first transmission circuit 122a. One end of the second transmission circuit 122b is electrically connected to the second radio frequency signal port, and the other end of the second transmission circuit 122b is electrically connected to at least one second radiating portion 1112. In this way, a second radio frequency signal may be transmitted to the second radiating portion 1112 through the second transmission circuit 122b. The first radio frequency signal and the second radio frequency signal may have a same current direction.

Refer to FIG. 13. During actual application, the reflector 130 is used as a reference ground of the antenna apparatus 100, and the reflector 130 may be spaced apart from the transmission circuit 122. In this way, the reflector 130 may be coupled to the transmission circuit 122 of the feed network, to affect an amplitude of a radio frequency signal on the transmission circuit 122.

According to the antenna apparatus 100 provided in this embodiment of this application, the transmission structure 1221 is configured as a structure including at least two connected side walls, and an included angle between the two adjacent side walls is greater than zero, so that different side walls of each transmission structure 1221 may be located on different surfaces of the insulation support 121. In this way, compared with a related technology in which an entire structure of a microstrip is attached to a surface of the insulation layer, an area occupied by the transmission structure 1221 on a same surface (for example, a horizontal surface) of the insulation support 121 can be reduced in this embodiment of this application, that is, a volume of the insulation support before the transmission line and the reflector can be reduced. In other words, a volume of an air medium between the surface of the transmission structure and the reflector can be increased. Because both a dielectric constant and a dissipation factor of the air medium are less than those of the insulation support, when the area of the air medium between the transmission structure and the reflector is increased, a dielectric loss of a radio frequency signal in the transmission structure during transmission can be reduced.

The part of the transmission structures 1221 is disposed along the z direction, and the part of the transmission structures 1221 is disposed along the x direction. In this way, a size occupied by the transmission structure 1221 on an xoy plane of the insulation support 121 can be reduced, and the antenna apparatus 100 is in a small three-dimensional space, so that a volume of the antenna apparatus 100 can be reduced. This facilitates miniaturization development of the antenna apparatus 100, and can further avoid a problem that the antenna apparatus 100 occupies a large space in one of two-dimensional spaces (for example, the xoy plane), thereby saving, installation space and facilitating assembly.

One side wall of each transmission structure 1221 is disposed opposite to the part of the structure of the reflector 130, so that the part of the structure of the reflector 130 may be used as a reference ground of the transmission circuit 122, and a radio frequency signal may be propagated along the transmission circuit 122 after being introduced into the transmission circuit 122.

Still refer to FIG. 15. In some embodiments, the transmission circuit 122 includes the first transmission circuit 122a and a second transmission circuit 122b. The first transmission circuit 122a includes a first primary transmission structure 12221 and at least one secondary transmission structure 1223. A first end 12221a of the first primary transmission structure is connected to the first radio frequency signal port, and a second end 12221b of the first primary transmission structure is electrically connected to at least one secondary transmission structure 1223. An end that is of each secondary transmission structure 1223 and that is away from a second end 12221b of the first primary transmission structure is electrically connected to one first radiating portion 1111.

For example, the second end 12221b of the first primary transmission structure may be electrically connected to three secondary transmission structures 1223, and each of the three secondary transmission structures 1223 is electrically connected to one first radiating portion 1111. In this way, a first radio frequency signal may be transmitted to three first radiating portions 1111 through the first transmission circuit 122a. Certainly, in some other embodiments, the second end 12221b of the first primary transmission line may be electrically connected to one, two, four, or more secondary transmission structures 1223.

As shown in FIG. 15, the second transmission circuit 122b includes a second primary transmission structure 12222 and at least one secondary transmission structure 1223. A first end of the second primary transmission structure 12222 is connected to a second radio frequency signal port (not shown in the figure), a second end of the second primary transmission structure 12222 is electrically connected to the at least one secondary transmission structure 1223, and an end that is of each secondary transmission structure 1223 and that is away from the second end 12221b of the first primary transmission structure is electrically connected to one second radiating portion 1112. For example, the second end of the second primary transmission structure 12222 may be electrically connected to three secondary transmission structures 1223, and each of the three secondary transmission structures 1223 is electrically connected to one second radiating portion 1112. In this way, the second radio frequency signal may be transmitted to the three second radiating portions 1112 through the second transmission circuit 122b. Certainly, in some other embodiments, the second end of the second primary transmission structure 12222 may be electrically connected to one, two, four, or more secondary transmission structures 1223.

The first transmission circuit 122a and the second transmission circuit 122b respectively transmit a radio frequency signal to the first radiating portion 1111 and the second radiating portion 1112. For example, the first transmission circuit 122a may transmit the first radio frequency signal to the first radiating portion 1111, and the second transmission circuit 122b may transmit the second radio frequency signal to the second radiating portion 1112. A direction of the first radio frequency signal may be the same as a direction of the second radio frequency signal.

Both the transmission circuit 122 and the radiating element 110 are disposed on the insulation support 121, and the insulation support 121 is disposed on the reflector 130. The following describes structures of the reflector 130 and the insulation support 121.

Still refer to FIG. 15. In this embodiment, the reflector 130 may include a bottom plate 131 and the radiating plate 132. The bottom plate 131 includes the first surface 133 and a second surface 134 that are oppositely disposed. In some embodiments, the first surface 133 of the reflector 130 is the first surface 133 of the bottom plate 131. The bottom plate 131 is located at a bottom end of the reflector 130, and the radiating plate 132 is located on the first surface 133. In the z direction, an end of the radiating plate 132 is located on the first surface 133, and another end extends in a direction away from the first surface 133. In the x direction, the radiating plate 132 extends from the first end 130a of the reflector to the second end 130b of the reflector, and the radiating plate 132 is located between the third end and the fourth end of the bottom plate 131. An included angle between the radiating plate 132 and the bottom plate 131 is a first included angle, and the first included angle is greater than zero. For example, the first included angle may be 90°. In other words, the bottom plate 131 is disposed perpendicular to the radiating plate 132, so that industrial aesthetics of the antenna apparatus 100 can be improved. Certainly, in some other embodiments, the first included angle may be another angle, for example, 60° or 80°.

The reflector 130 is configured as a structure having the bottom plate 131 and the radiating plate 132, an end of the radiating plate 132 is located on the first surface 133 of the bottom plate 131, and another end extends in a direction away from the first surface 133. The included angle between the radiating plate 132 and the bottom plate 131 is the first included angle, and the first included angle is greater than zero. In this way, the bottom plate 131 and the radiating plate 132 of the reflector 130 may be located in a three-dimensional space (xyz), for example, a part of the reflector 130, that is, the radiating plate 132, is disposed on the bottom plate 131 along the z direction. In this way, in a case in which a total area of the reflector 130 is the same as that in a related technology, an area of a two-dimensional space (the xoy plane) in which the bottom plate 131 of the reflector 130 is located may be reduced in this embodiment of this application, so that a two-dimensional space occupied by an antenna structure in the xoy plane can be reduced, thereby facilitating installation and assembly, and the like.

The first end 130a of the reflector and the first end of the bottom plate 131 are located at the same end, the second end 130b of the reflector and the second end of the bottom plate 131 are located at the same end, the third end 130c of the reflector and the third end of the bottom plate 131 are located at the same end, and the fourth end 130d of the reflector and the fourth end of the bottom plate 131 are located at the same end.

In some embodiments, raised walls are respectively disposed along the z direction at the third end and the fourth end of the bottom plate 131, and the insulation support 121 is fastened between two raised walls, so that the insulation support 121 can be stably disposed on the reflector 130, thereby improving stability of the antenna apparatus 100.

In some embodiments, the insulation support 121 may include a base 1211 and the support wall 1212. The base 1211 is disposed opposite to the bottom plate 131, and the base 1211 and the bottom plate 131 are spaced apart along the z direction. In the first direction (that is, the z direction), an end of the support wall 1212 is located on a surface that is of the base 1211 and that is away from the bottom plate 131, and another end extends in a direction away from the base 1211. At least one support wall 1212 is spaced apart along the x direction on the surface that is of the base 1211 and that is away from the bottom plate 131. For example, there may be three support walls 1212. Certainly, in another embodiment, there may be one, two, four, or more support walls 1212. The quantity of support walls 1212 is not further limited in this embodiment.

The insulation support 121 is configured to include the base 1211 and the support wall 1212, so that a part of a structure of the insulation support 121 is disposed opposite to the reflector 130, and the transmission structure 1221 disposed on the insulation support 121 is disposed opposite to the reflector 130, thereby ensuring that a radio frequency signal in the transmission structure 1221 may be propagated along the transmission structure 1221. An included angle between the support wall 1212 and the base 1211 is set to be greater than zero. In this way, the support wall 1212 and the base 1211 of the insulation support 121 may also be located in a three-dimensional space, so that an area occupied by the insulation support 121 in a two-dimensional space (for example, the xoy plane) can be reduced, and a volume of the antenna apparatus 100 in the two-dimensional space can be reduced, thereby facilitating installation.

In this embodiment, the support wall 1212 may be disposed along the y direction, a first end of the support wall 1212 is close to the third end of the bottom plate 131, and a second end of the support wall 1212 is close to the fourth end of the bottom plate 131. The included angle between the support wall 1212 and the base 1211 is a second included angle, and the second included angle is greater than zero. The third direction is a direction (that is, the y direction) from the third end to the fourth end of the reflector 130. In some embodiments, the second included angle may be 90°, that is, the base 1211 is perpendicular to the support wall 1212. Certainly, in some other embodiments, the second included angle may be another angle, for example, 60° or 80°.

In some embodiments, the base 1211 may include a first raised wall 1215 and a second raised wall 1216. Both the first raised wall 1215 and the second raised wall 1216 are disposed along the second direction. The first raised wall 1215 is disposed opposite to the second raised wall 1216, and a gap exists between the first raised wall 1215 and the second raised wall 1216, to enable a first avoidance space 1213 to be formed between the first raised wall 1215 and the second raised wall 1216. The first avoidance space 1213 is provided along the second direction, and the first avoidance space 1213 is located between the third end and the fourth end of the bottom plate 131. A part of a structure of the radiating plate 132 is located in the first avoidance space 1213, and gaps exist between the radiating plate 132 and the first raised wall 1215 and between the radiating plate 132 and the second raised wall 1216.

The first avoidance space is formed between the first raised wall 1215 and the second raised wall 1216, to provide a disposing space for the radiating plate 132. In this way, it can be further ensured that a gap may exist between the radiating plate 132 and the transmission structure 1221, so that a part of side walls of the transmission structure 1221 may be disposed opposite to the radiating plate 132, to ensure that a radio frequency signal in the transmission structure 1221 can be propagated to the radiating element 110 along the transmission structure 1221.

For example, the support wall 1212 may be further provided with a second avoidance space 1214, the second avoidance space 1214 is located between the first end and the second end of the support wall 1212, and the first avoidance space 1213 is in communication with the second avoidance space 1214. In the z direction, the second avoidance space 1214 extends, in the direction away from the base 1211, from an end that is of the first avoidance space 1213 and that is away from the bottom plate 131. An included angle between the support wall 1212 and the radiating plate 132 is a third included angle, and the third included angle is greater than zero. A part of the structure of the radiating plate 132 is located in the second avoidance space 1214, and a gap exists between the radiating plate 132 and a surface that is of the support wall 1212 and that faces the second avoidance space 1214.

The second avoidance space 1214 is disposed, so that a height of the radiating plate 132 in a vertical direction (that is, the z direction) of the bottom plate 131 is large, and the radiating plate 132 has more space to place the first transmission sub-structure 12214, to increase a length of the first transmission sub-structure 12214, thereby increasing the length of the first transmission sub-structure 12214, reducing wiring density, and reducing inter-line coupling.

Still refer to FIG. 13. Both the first radiating portion 1111 and the second radiating portion 1112 are disposed on the surface of the support wall 1212, the first radiating portion 1111 is located between a first end of the support wall 1212 and the second avoidance space 1214, and the second radiating portion 1112 is located between a second end of the support wall 1212 and the second avoidance space 1214. The first radiating portion 1111 is electrically connected to the first transmission circuit 122a, and the second radiating portion 1112 is electrically connected to the second transmission circuit 122b, so that a radio frequency signal is input to the first radiating portion 1111 and the second radiating portion 1112.

In this embodiment of this application, both the first primary transmission structure 12221 and the second primary transmission structure 12222 are disposed on a surface of the base 1211. The first primary transmission structure 12221 is located between the radiating plate 132 and the third end of the bottom plate 131. The second end 12221b of the first primary transmission structure is electrically connected to at least one secondary transmission structure 1223, an end that is of each secondary transmission structure 1223 of the first primary transmission structure 12221 and that is away from the second end 12221b of the first primary transmission structure is electrically connected to a ground end of one first radiating portion 1111, and an open end of the first radiating portion 1111 extends along the y direction in a direction away from the radiating plate 132. The second primary transmission structure 12222 is located between the radiating plate 132 and the fourth end of the bottom plate 131. The second end of the second primary transmission structure 12222 is electrically connected to the at least one secondary transmission structure 1223, an end that is of each secondary transmission structure 1223 of the second primary transmission structure 12222 and that is away from the second end of the second primary transmission structure 12222 is electrically connected to a ground end of one second radiating portion 1112, and an open end of the second radiating portion 1112 extends along the y direction in the direction away from the radiating plate 132.

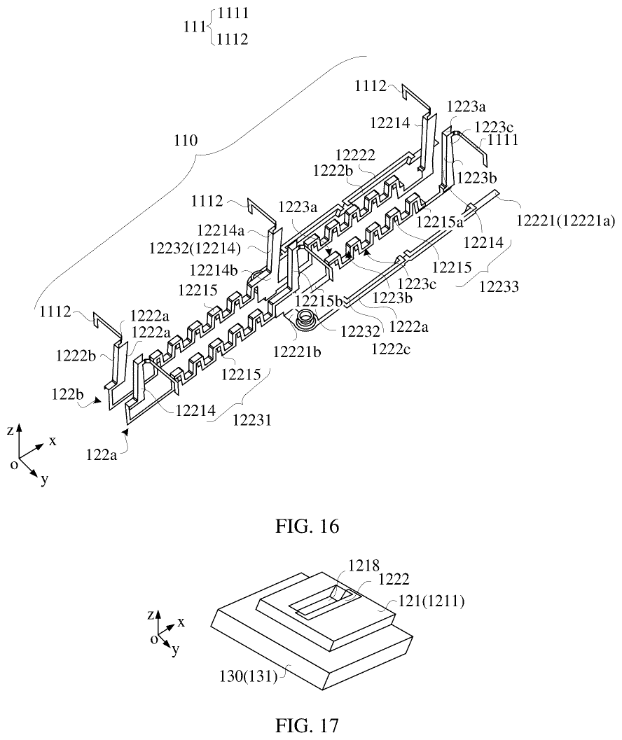

Refer to FIG. 16, the first transmission circuit 122a includes a first primary transmission structure 12221 and three secondary transmission structures 1223. A first end 12221a of the first primary transmission structure is connected to a first radio frequency signal port (not shown in the figure), a second end 12221b of the first primary transmission structure is electrically connected to the three secondary transmission structures 1223, and an end that is of each secondary transmission structure 1223 and that is away from the second end 12221b of the first primary transmission structure is electrically connected to one first radiating portion 1111. A first end of the second primary transmission structure 12222 is connected to a second radio frequency signal port (not shown), a second end of the second primary transmission structure 12222 is electrically connected to the three secondary transmission structures 1223, and an end that is of each secondary transmission structure 1223 and that is away from the second end of the second primary transmission structure 12222 is electrically connected to one second radiating portion 1112.

Certainly, there may be but is not limited to three secondary transmission structures 1223 in the first transmission circuit 122a and the second transmission circuit 122b. In some embodiments, there may be one, two, four, or more secondary transmission structures 1223 in the first transmission circuit 122a and the second transmission circuit 122b. The quantity of secondary transmission structures 1223 in the first transmission circuit 122a and the second transmission circuit 122b is not further limited in this embodiment of this application.

It should be noted that three secondary transmission structures 1223 connected to the first primary transmission structure 12221 are connected in parallel, and the three secondary transmission structures 1223 connected to the second primary transmission structure 12222 are connected in parallel. Therefore, the transmission circuit 122 may drive three groups of radiating portions, so that the antenna apparatus 100 may be a one-to-three drive unit.

In a possible implementation, each secondary transmission structure 1223 may include at least one transmission sub-structure 1221. A transmission sub-structure 1221 close to the second end of the primary transmission structure 1222 is electrically connected to the primary transmission structure 1222. A transmission sub-structure 1221 close to the radiating portion is electrically connected to the radiating portion. Adjacent transmission sub-structures 1221 are connected in series.

It should be noted that structures of different secondary transmission structures 1223 may be the same or may be different. As shown in FIG. 16, in a plurality of secondary transmission structures 1223, a part of the secondary transmission structures 1223 includes one transmission sub-structure 1221, and a part of the secondary transmission structures 1223 includes two transmission sub-structures 1221 connected in series. Certainly, in some other embodiments, the secondary transmission structure 1223 may alternatively include three transmission sub-structures 1221 connected in series. A quantity of transmission sub-structures 1221 included in each secondary transmission structure 1223 is not further limited in this embodiment.

In this embodiment, the secondary transmission structure 1223 may include at least one transmission sub-structure 1221, and the transmission sub-structure 1221 may include a first transmission sub-structure 12214 and a second transmission sub-structure 12215. Each secondary transmission structure 1223 includes one first transmission sub-structure 12214, because the first transmission sub-structure 12214 may be configured to be electrically connected to a radiating portion. A part of the secondary transmission structures 1223 may alternatively include the second transmission sub-structure 12215, and whether the second transmission sub-structure 12215 is disposed in the secondary transmission structure 1223 and a length of the second transmission sub-structure 12215 are related to a distance between two adjacent groups of radiating portions in the x direction and a connection point between the secondary transmission structure 1223 and the primary transmission structure 1222. For example, if the distance between two adjacent groups of radiating portions in the x direction is large, and a distance between the secondary transmission structure 1223 and the connection point of the primary transmission structure 1222 is large, a length of the second transmission sub-structure 12215 needs to be long.

For ease of description, in this embodiment, the three secondary transmission structures 1223 are respectively a first secondary transmission structure 12231, a second secondary transmission structure 12232, and a third secondary transmission structure 12233. In the x direction, the second secondary transmission structure 12232 is located between the first secondary transmission structure 12231 and the third secondary transmission structure 12233. Both the first secondary transmission structure 12231 and the third secondary transmission structure 12233 include the first transmission sub-structure 12214 and the second transmission sub-structure 12215, and the second secondary transmission structure 12232 includes the first transmission sub-structure 12214.

In an optional implementation, the antenna apparatus 100 is of an axisymmetric structure, and a symmetry axis of the antenna apparatus 100 is a plane on which the radiating plate 132 is located. The following describes a symmetric structure in which the antenna apparatus 100 uses the radiating plate 132 as a symmetry axis.

In this embodiment, the first transmission circuit 122a may have a same shape as the second transmission circuit 122b, and the first transmission circuit 122a and the second transmission circuit 122b are symmetrically disposed on two sides of the radiating plate 132 by using the radiating plate 132 as a symmetry axis. Each group of radiating portions is also symmetrically disposed on the two sides of the radiating plate 132 by using the radiating plate 132 as a symmetry axis. Because the first transmission circuit 122a have the same shape as the second transmission circuit 122b, the following uses the first transmission circuit 122a as an example for description. For description of the second transmission circuit 122b, refer to the description of the first transmission circuit 122a. In this embodiment, the shape of the second transmission circuit 122b is not described again.

The following describes the first transmission circuit 122a with reference to the accompanying drawings.

In this embodiment, as shown in FIG. 16, the first transmission circuit 122a includes the first primary transmission structure 12221 and three secondary transmission structures 1221 connected to the first primary transmission structure 12221. A connection point between the primary transmission structure 1222 and the secondary transmission structure 1223 is close to the second secondary transmission structure 12232. The second secondary transmission structure 12232 includes one first transmission sub-structure 12214, both the first secondary transmission structure 12231 and the third secondary transmission structure 12233 include one first transmission sub-structure 12214 and one second transmission sub-structure 12215.

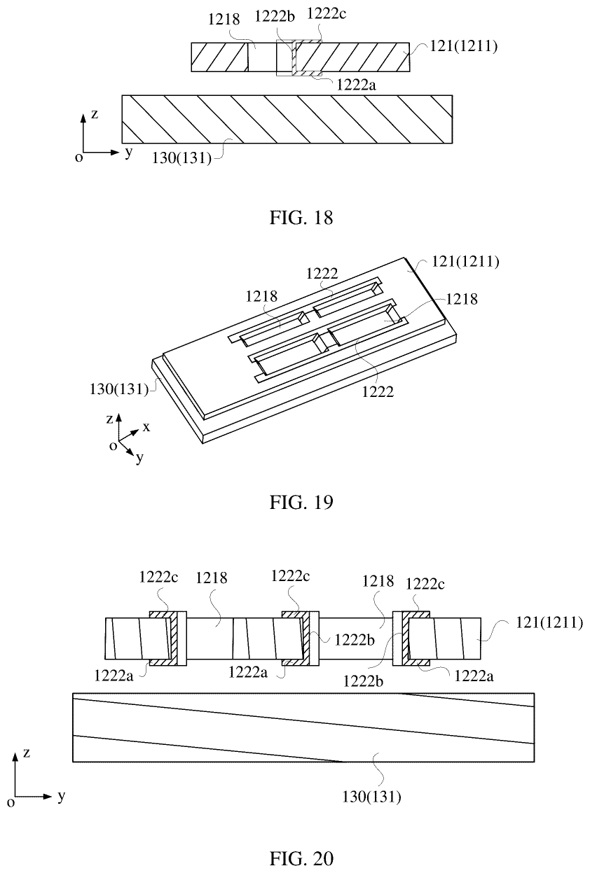

With reference to FIG. 16, FIG. 17, and FIG. 18, the first primary transmission structure 12221 may include a first side wall 1222a, a second side wall 1222b, and a third side wall 1222c. The first side wall 1222a is disposed opposite to the reflector 130, and a gap exists between the first side wall 1222a and the reflector 130. For example, the first side wall 1222a is disposed opposite to the first surface 133 of the bottom plate 131, and a gap exists between the first side wall 1222a and the first surface 133 of the bottom plate 131. A length of the first side wall 1222a is greater than or equal to a length of the second side wall 1222b. The first side wall 1222a is electrically connected to the secondary transmission structure 1223. The second side wall 1222b is fixedly connected to at least a part of the first side wall 1222a, and an included angle between the second side wall 1222b and the first side wall 1222a is greater than zero. For example, the included angle between the second side wall 1222b and the first side wall 1222a may be 90°.

Certainly, in another embodiment, the included angle between the second side wall 1222b and the first side wall 1222a may alternatively be another angle, for example, may be 120°. The insulation support 121 is provided with a through hole 1218 for installing the first primary transmission structure 12221. An end that is of the second side wall 1222b and that is away from the first side wall 1222a extends along an inner wall of the through hole 1218 in a direction away from the first side wall 1222a. The third side wall 1222c is connected to the second side wall 1222b, and an end that is of the third side wall 1222c and that is away from the second side wall 1222b extends along a part of the surface of the insulation support 121 around the through hole 1218.

The first primary transmission structure 12221 is configured as a structure including the first side wall 1222a, the second side wall 1222b, and the third side wall 1222c, and the first side wall 1222a is disposed opposite to the reflector 130. In this way, a volume of the insulation support connected to the first primary transmission structure 12221 can be reduced. In other words, an area of an air medium between the surface of the first primary transmission structure 12221 and the reflector 130 is increased. Because both a dielectric constant and a dissipation factor of the air medium are less than those of the insulation support 121, when the area of the air medium between the first primary transmission structure 12221 and the reflector 130 is increased, a dielectric loss in the first primary transmission structure 12221 during energy transmission can be reduced.

The reflector 130 is provided with the through hole 1218, so that different side walls of the first primary transmission structure 12221 may be located on different surfaces of the reflector 130, and an included angle between the different side walls of the first primary transmission structure 12221 may be greater than zero.

It should be noted that, in this embodiment, a shape of the through hole 1218 is a quadrilateral. Certainly, in another embodiment, the through hole 1218 may alternatively be in another shape, for example, a circle, a triangle, or a polygon. In this embodiment, the shape of the through hole 1218 is not further limited.

The following uses an example in which the through hole 1218 is a quadrilateral for description. In this embodiment, lengths of the second side wall 1222b and the third side wall 1222c on the first primary transmission structure 12221 are not limited in this embodiment of this application. For example, a part that is of the first primary transmission structure 12221 and that is located in the through hole 1218 may occupy a cycle, a half cycle, a quarter cycle, or the like of an inner wall of the through hole 1218. In other words, the second side wall 1222b may be located on one or more side surfaces of the inner wall of the through hole 1218, and may be specifically set according to a requirement. In this embodiment, positions of a start point and an end point of the part that is of the first primary transmission structure 12221 and that is located in the through hole 1218 are not further limited.

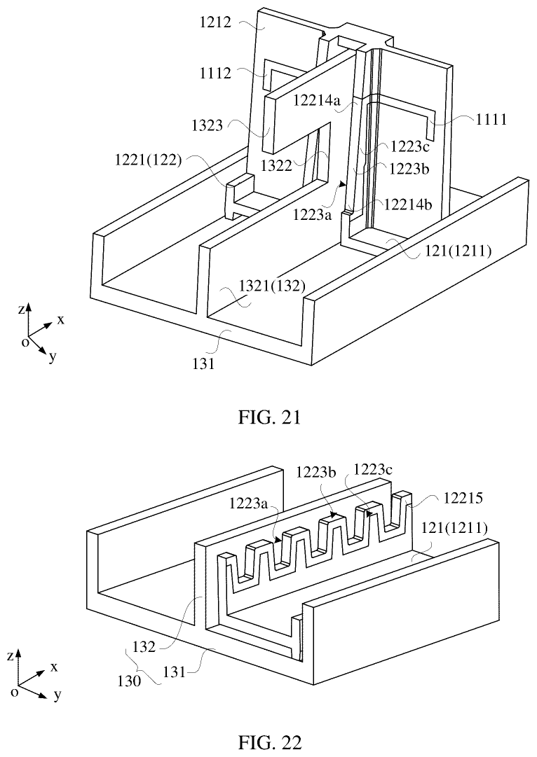

Certainly, to increase the lengths of the second side wall 1222b and the third side wall 1222c, a plurality of through holes 1218 may be provided. As shown in FIG. 19 and FIG. 20, there are four through holes 1218, and the four through holes 1218 are distributed in a matrix. A part of the first primary transmission structure 12221 is disposed in each through hole 1218. The plurality of through holes 1218 are provided, so that the first primary transmission structure 12221 may be disposed at a plurality of positions, thereby improving design flexibility of the first primary transmission structure 12221. A specific quantity of the through holes 1218 and a disposition position of the through hole 1218 are not further limited in this embodiment of this application.

In an optional implementation, the first transmission sub-structure 12214 is disposed on a surface of the support wall 1212 along the z direction, the second transmission sub-structure 12215 is disposed on the surface of the base 1211 along the x direction, the first end 12214a of the first transmission sub-structure is located at an end that is of the support wall 1212 and that is close to the base 1211, and the second end 12214b of the first transmission sub-structure extends along the surface of the support wall 1212 in the direction away from the base 1211. An included angle between the first transmission sub-structure 12214 and a plane on which the base 1211 is located is greater than zero. Each first transmission sub-structure 12214 corresponds to one radiating portion, and an end that is of the first transmission sub-structure 12214 and that is away from the base 1211 is electrically connected to the radiating portion.

An end, close to the base 1211, of the first transmission sub-structure 12214 of the first secondary transmission structure 12231 and the third secondary transmission structure 12233 is electrically connected to a first end 12215a of the second transmission sub-structure, and a second end 12215b of the second transmission sub-structure is electrically connected to the first primary transmission structure 12221. An included angle between the first transmission sub-structure 12214 and the second transmission sub-structure 12215 is greater than zero. For example, the included angle between the first transmission sub-structure 12214 and the second transmission sub-structure 12215 may be 90°, 100°, or the like.

It should be noted that, a difference between the first transmission sub-structure and the second transmission sub-structure 12215 lies in that the first transmission sub-structure 12214 and the second transmission sub-structure 12215 are disposed in different directions. For example, the first transmission sub-structure 12214 is disposed along the z direction, and the second transmission sub-structure 12215 is disposed along the x direction. A quantity of side walls of the first transmission sub-structure 12214 may be the same as a quantity of side walls of the second transmission sub-structure 12215. For example, both the first sub-transmission and the second transmission sub-structure 12215 may be of a strip-line structure having two side walls, or a strip-line structure having three side walls.

Shapes of the first transmission sub-structure 12214 and the second transmission sub-structure 12215 in an extension direction of the first transmission sub-structure 12214 and the second transmission sub-structure 12215 may be configured according to a specific situation. For example, the first transmission sub-structure 12214 may be of a straight-line structure, and the second transmission sub-structure 12215 may be of a fold-line structure; or the first transmission sub-structure 12214 may be of a fold-line structure, and the second transmission sub-structure 12215 may be of a straight-line structure; or both the first transmission sub-structure 12214 and the second transmission sub-structure 12215 are of straight-line structures; or both the first transmission sub-structure 12214 and the second transmission sub-structure 12215 are of fold-line structures. In this embodiment, shapes of the first transmission sub-structure 12214 and the second transmission sub-structure 12215 in an extension direction of the first transmission sub-structure 12214 and the second transmission sub-structure 12215 are not specifically limited.

The following uses an example in which the first transmission sub-structure 12214 is a straight-line structure and the second transmission sub-structure 12215 is a fold-line structure for description.

In this embodiment, as shown in FIG. 16, FIG. 21, and FIG. 22, both the first transmission sub-structure 12214 and the second transmission sub-structure 12215 include a fourth side wall 1223a, a fifth side wall 1223b, and a sixth side wall 1223c. The fourth side wall 1223a is disposed opposite to a part of a structure of the radiating plate 132 on the reflector 130, and a gap exists between the fourth side wall 1223a and the reflector 130. The fifth side wall 1223b is connected to the fourth side wall 1223a, and an included angle between the fourth side wall 1223a and the fifth side wall 1223b is greater than zero. The sixth side wall 1223c is connected to the fifth side wall 1223b, an included angle between the fifth side wall 1223b and the sixth side wall 1223c is greater than zero, and both the fourth side wall 1223a and the sixth side wall 1223c are located on a surface on which the fifth side wall 1223b is connected to the insulation support 121, and are respectively located at two ends of the fifth side wall 1223b in the y direction.

In this embodiment, the fourth side wall 1223a is disposed opposite to the radiating plate 132, and the fourth side wall 1223a is disposed opposite to the sixth side wall 1223c, so that the fourth side wall 1223a and the sixth side wall 1223c share a support wall 1212 of a same part of the insulation support 121. Because the insulation support 121 has a dielectric constant and a dissipation factor, after a volume of the insulation support 121 connected to the transmission structure is reduced, a dielectric loss in the transmission structure 1221 during energy transmission can be reduced. In addition, the volume of the insulation support 121 connected to the transmission structure is reduced, which is equivalent to an increase in a proportion of an air medium between surfaces of the first transmission sub-structure 12214 as well as the second transmission sub-structure 12215 and the reflector 130. Because both a dielectric constant and a dissipation factor of the air medium are less than those of the insulation support 121, when an area of the air medium between the transmission sub-structure 1221 and the reflector 130 is increased, a dielectric loss in the transmission sub-structure 1221 during radio frequency signal transmission can be reduced.

As shown in FIG. 15, the radiating plate 132 may include a first connection part 1321, a second connection part 1322, and a radiating part 1323. The first connection part 1321 is located at an end that is of the radiating plate 132 and that is close to the bottom plate 131, and the second connection part 1322 is located between the first connection part 1321 and the radiating part 1323. The radiating part 1323 extends, along the x direction in a direction away from the second connection part 1322, from an end that is of the second connection part 1322 and that is away from the first connection part 1321, and the radiating part 1323 may be the third radiating portion.

Because the first radiating portion 1111 and the second radiating portion 1112 are respectively located on two sides of the radiating plate 132 on the reflector 130, and extend along a direction opposite to the y direction, after a radio frequency signal is introduced into the first radiating portion 1111 and the second radiating portion 1112, for example, after a radio frequency signal in a same direction is introduced into the first radiating portion 1111 and the second radiating portion 1112, the radio frequency signal is transmitted to the first radiating portion 1111 and the second radiating portion 1112 through the first transmission sub-structure 12214 disposed along the z direction. Because the first transmission sub-structure 12214 is disposed opposite to a part of a structure of the radiating plate 132, a coupled radio frequency signal may be generated on the radiating plate 132, and the coupled radio frequency signal may be transmitted along the transmission structure 1221. Because the radiating part 1323 of the radiating plate 132 extends along the x direction in a direction away from the second connection part 1322, the radiating part 1323 may be perpendicular to both the first radiating portion 1111 and the second radiating portion 1112, a radio frequency signal in a first polarization direction may be formed between the radiating part 1323 and the first radiating portion 1111, and a radio frequency signal in a second polarization direction may be formed between the radiating part 1323 and the second radiating portion 1112. It may be understood that the first polarization direction is different from the second polarization direction. For example, the first polarization direction may be a +45° polarization direction, and the second polarization direction may be a −45° polarization direction. Therefore, dual-polarized feeding of the transmission circuit 122 is implemented.

The radiating part 1323 is used as the third radiating portion of the radiating element 110, so that the antenna apparatus 100 has three radiating portions, radiating efficiency of the antenna apparatus 100 may be improved, and the antenna apparatus can be a dual-polarized dipole antenna apparatus.

With reference to FIG. 13, FIG. 16, FIG. 21, and FIG. 22, in this embodiment, the first end 12214a of each first transmission sub-structure is electrically connected to one first radiating portion 1111. The second end 12214b of the first transmission sub-structure of the second secondary transmission structure 12232 is electrically connected to the second end 12221b of the first primary transmission structure. The second end 12214b of the first transmission sub-structure of the first secondary transmission structure 12231 and the third secondary transmission structure 12233 is electrically connected to the first end 12215a of the second transmission sub-structure. The second end 12215b of the second transmission sub-structure is electrically connected to the second end of the primary transmission structure 1222. The included angle between the first transmission sub-structure 12214 and the second transmission sub-structure 12215 is greater than zero.

It should be noted that, electrical connections between the first transmission sub-structure 12214 and the second transmission sub-structure 12215, between the first transmission sub-structure 12214 and the first primary transmission structure 12221, and between the second transmission sub-structure 12215 and the first primary transmission structure 12221 may be implemented by using connection lines. A connection line located on the first primary transmission structure 12221 may be an extension wall connected to the first side wall 1222a of the primary transmission structure 1222, and the extension wall and the first side wall 1222a of the first transmission sub-structure 12214 are disposed on a same surface of the base 1211.

In some embodiments, the extension wall connected to the first side wall 1222a is a part of the first side wall 1222a. A connection line located between the first transmission sub-structure 12214 and the second transmission sub-structure 12215 may be an extension wall of at least one of the fourth side wall 1223a, the fifth side wall 1223b, or the sixth side wall 1223c. The extension wall may implement electrical connection between the first transmission sub-structure 12214 and the second transmission sub-structure 12215. Certainly, a specific shape of the connection line is not further limited in this embodiment, provided that the first transmission sub-structure 12214 and the second transmission sub-structure 12215 can be electrically connected.

For example, the first transmission sub-structure 12214 on the second secondary transmission structure 12232 is electrically connected to the first primary transmission structure 12221 through a connection line, on the first secondary transmission structure, the first transmission sub-structure 12214 is electrically connected to the second transmission sub-structure 12215 through a connection line, and on the third secondary transmission structure, the first transmission sub-structure 12214 is electrically connected to the second transmission sub-structure 12215 through a connection line.

In some embodiments, a manufacturing process of the transmission circuit 122 includes but is not limited to injection molding, sandblasting coarsening, pre-processing (nickel plating), laser engraving, electroplating (coated copper plating, copper acid plating, and the like), copper protection, and the like. In addition, the transmission circuit 122 may be fastened to the insulation support 121 in a manner such as electroplating. A manner in which the transmission circuit 122 is fixedly connected to the insulation support 121 is not further limited in this embodiment.

As shown in FIG. 13 and FIG. 16, a hole-shaped structure 1219 is disposed on the base 1211 of the insulation support 121. The first transmission circuit 122a corresponds to one hole-shaped structure 1219, the second transmission circuit 122b corresponds to one hole-shaped structure 1219, and the hole-shaped structure 1219 may be used to fasten the insulation support 121. The hole-shaped structure 1219 may be cylindrical, or certainly may be in another shape. A specific shape of the hole-shaped structure 1219 is not further limited in this embodiment.

The transmission sub-structure 1221 is configured as a structure including the first transmission sub-structure 12214, and the first transmission sub-structure 12214 is disposed on the surface of the insulation support 121 along the z direction. Compared with a related technology in which the microstrip is disposed on an insulation layer, in this embodiment of this application, a space of the insulation support 121 occupied by the first transmission sub-structure 12214 in a horizontal direction (that is, the direction in which the xoy plane is located) can be reduced, and an area of the insulation support 121 in the horizontal direction can be reduced. In other words, a small insulation support 121 may be used to meet a layout requirement of the first transmission sub-structure 12214, this facilitates miniaturization development of the antenna apparatus 100. In addition, because the first transmission sub-structure 12214 is disposed along the first direction, compared with a related technology in which a plurality of microstrips are disposed in parallel, in this embodiment of this application, a coupling effect between the first transmission sub-structure 12214 and another transmission structure 1221 can be reduced, thereby improving a directivity coefficient of the antenna apparatus 100 and improving radiating efficiency of the antenna apparatus 100.

The second transmission sub-structure 12215 is disposed, so that the first transmission sub-structure 12214 can be conveniently connected to the primary transmission structure 1222. In addition, a length of the secondary transmission structure 1223 may be further increased by disposing the second transmission sub-structure 12215. In this way, wiring density may be reduced, thereby reducing inter-line coupling.

In some embodiments, as shown in FIG. 21 and FIG. 22, the first transmission sub-structure 12214 may be of a straight-line structure. The second transmission sub-structure 12215 may be of a fold-line structure. The fold-line structure is provided with at least one raised part, and the at least one raised part is spaced apart along the second direction.

The transmission sub-structure 1221 is configured as the straight-line structure, so that the transmission sub-structure 1221 is simple and convenient for production. The transmission sub-structure 1221 is configured as the fold-line structure, so that a length of the transmission sub-structure 1221 may be increased without increasing sizes of the insulation support 121 in the z direction and the x direction, thereby reducing wiring density and reducing inter-line coupling.

In an optional implementation, as shown in FIG. 21, the support wall 1212 is provided with a first mounting part 1217, and the first mounting part 1217 protrudes from the surface of the support wall 1212 in a first end close to the bottom plate 131. Certainly, in some embodiments, the first mounting part 1217 may alternatively protrude in a second end close to the bottom plate 131, and a surface of the first mounting part 1217 is disposed opposite to the radiating plate 132. The first transmission sub-structure 12214 is disposed on a surface of the first mounting part 1217, the fourth side wall 1223a of the first transmission sub-structure 12214 is located on a surface that is of the first mounting part 1217 and that is opposite to the radiating plate 132, the fifth side wall 1223b of the first transmission sub-structure 12214 is located on a surface that is of the first mounting part 1217 and that faces the first end or the second end of the bottom plate 131, the sixth side wall 1223c of the first transmission sub-structure 12214 is located on a surface that is of the first mounting part 1217 and that is away from the radiating plate 132, and the sixth side wall 1223c is electrically connected to the first radiating portion 1111.

Certainly, in some embodiments, the first mounting part 1217 may alternatively not be disposed. The first transmission sub-structure 12214 may include only the fourth side wall 1223a and the fifth side wall 1223b. The fourth side wall 1223a is disposed opposite to the radiating plate 132. The fifth side wall 1223b may be electrically connected to the first radiating portion 1111 (not shown in the figure).

Alternatively, the first mounting part 1217 is in another shape. For example, the first mounting part 1217 is alternatively provided with recesses and protrusions (not shown in the figure) that are alternately arranged. In this way, the first transmission sub-structure 12214 may be of a fold-line structure, thereby extending a length of the first transmission sub-structure 12214.

In this embodiment, as shown in FIG. 21, the first raised wall 1215 is provided with a plurality of protrusions and recesses that are alternately arranged. The plurality of protrusions and recesses that are alternately arranged extend along the x direction. The second transmission sub-structure 12215 is disposed on a surface of the first raised wall 1215, to enable the second transmission sub-structure 12215 to be of the fold-line structure. In the x direction, a length of the second transmission sub-structure 12215 is greater than a length of orthographic projection of the second transmission sub-structure 12215 in the z direction.

The fourth side wall 1223a of the second transmission sub-structure 12215 is disposed opposite to the radiating plate 132, the fifth side wall 1223b is located on a top surface of the first raised wall 1215, and the sixth side wall 1223c is disposed opposite to the fourth side wall 1223a.

It should be noted that the second raised wall 1216 has a same structure as the first raised wall 1215, and the second transmission sub-structure 12215 of the second transmission circuit 122b is disposed on the second raised wall 1216. Therefore, the structure of the second raised wall 1216 may be determined according to the description of the first raised wall 1215, and is not described again in this embodiment.

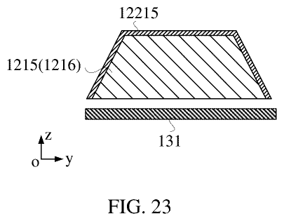

It may be understood that, a length of the second transmission sub-structure 12215 is adjusted by changing heights of the first raised wall 1215 and the second raised wall 1216 in the z direction, and a quantity of the plurality of protrusions and recesses that are alternately arranged on the first raised wall 1215 and the second raised wall 1216. This may be set according to a requirement. Certainly, in some embodiments, the first raised wall 1215 and the second raised wall 1216 may alternatively not be provided with the plurality of protrusions and recesses that are alternately arranged, for example, only one protrusion may be provided (as shown in FIG. 23). In this embodiment, the heights of the first raised wall 1215 and the second raised wall 1216 in the z direction, and the quantity of the plurality of protrusions and recesses that are alternately arranged are not further limited in this embodiment.

Certainly, in some embodiments, the second transmission sub-structure 12215 may include only the fourth side wall 1223a and the fifth side wall 1223b. The fourth side wall 1223a is disposed opposite to the reflector 130, the fifth side wall 1223b is disposed on a top end of the first raised wall 1215 or the second raised wall 1216, and a large included angle between the fifth side wall 1223b and the fourth side wall 1223a is greater than zero. For structures of the fifth side wall 1223b and the fourth side wall 1223a, refer to a structure without the sixth side wall 1223c in FIG. 22.

In an optional implementation, the first included angle is 90°, the second included angle is 90°, and the third included angle is 90°. In this way, industrial aesthetics of the antenna apparatus 100 can be improved. Certainly, in another embodiment, the first included angle, the second included angle, and the third included angle may alternatively be other values, and values of the first included angle, the second included angle, and the third included angle may be the same or may be different. Specifically, this is not further limited in this embodiment.

It should be noted that shapes of the primary transmission structure, the first transmission sub-structure, and the second transmission sub-structure shown in figures may be specifically configured according to a specific situation, provided that the primary transmission structure, the first transmission sub-structure, and the second transmission sub-structure each include at least two side walls.

In addition, shapes of all the transmission structures in the antenna apparatus provided in the third aspect are deformed shapes of the transmission lines provided in the first aspect, and shapes of all the transmission structures in the antenna apparatus fall within the protection scope of the transmission structures in the first aspect.

It should be noted that a material of the insulation support 121 may include one material or a mixture of a plurality of materials. The insulation support 121 may be a printed circuit board (printed circuit board, PCB for short), and both the transmission circuit 122 and the radiating element 110 may be printed on a surface of the insulation support 121.

The insulation support 121 is used as a dielectric substrate, that is, an intermediate dielectric layer, of the transmission circuit 122 and the radiating element 110, so that the transmission circuit 122 and the radiating element 110 are stably disposed on the surface of the insulation support 121, thereby improving structural stability of the antenna apparatus 100.

The antenna apparatus 100 in embodiments of this application may be a wideband antenna, or may be a narrowband antenna. For example, an operating band of the antenna apparatus 100 may be a band of 1690 MHz to 2690 MHz or a band of 690 MHz to 960 MHz.

In embodiments of this application, the antenna apparatus 100 is disposed in a radio frequency device, for example, a base station device, so that signal sending and receiving performance of the radio frequency device is ensured. In addition, compared with the antenna apparatus 100 in a related technology, the antenna apparatus 100 in this embodiment of this application has a simple structure, is convenient to manufacture, and occupies a small space. In this way, an array antenna may be disposed in the radio frequency device, that is, integrity of the radio frequency device is improved while a size of the radio frequency device is ensured to be within a proper range.

It should be understood that, in this application, “electrical connection” may be understood that components contact physically and are electrically connected, or may be understood as coupled connection. It may also be understood as a form in which different components in a circuit structure are connected through physical circuits that can transmit an electrical signal, such as a printed circuit board (printed circuit board, PCB) copper foil or a conducting wire. “Coupling” may be understood as electrically connected through air in an indirect coupling manner. The coupling in this application may be understood as capacitive coupling. For example, an equivalent capacitor is formed by coupling between gaps of two conductive members, to implement signal transmission. A person skilled in the art may understand that a coupling phenomenon is a phenomenon that inputs and outputs of two or more circuit elements or electrical networks closely cooperate with each other and affect each other, and energy is transmitted from one side to the other side through interaction. A “communication connection” may refer to electrical signal transmission, including a wireless communication connection and a wired communication connection. The wireless communication connection does not require a physical medium and does not belong to a connection relationship that defines a construction of a product. Both “connection” and “being connected to” may mean a mechanical connection relationship or a physical connection relationship, that is, a connection between A and B or that A is connected to B may mean that there is a fastening component (such as a screw, a bolt, or a rivet) between A and B, or A and B are in contact with each other and A is difficult to be separated from B. Opposite/disposed opposite to each other: That A is disposed opposite to B may mean that A is disposed opposite to B or A and B are disposed face to face (opposite to, or face to face).

In the description of embodiments of this application, it should be noted that, unless otherwise explicitly stipulated and restricted, terms “installation”, “connect”, and “connection” should be understood broadly. For example, the connection may be a fixed connection, or may be an indirect connection through an intermediate medium, or may be an internal communication between two components, or may be an interactive relationship between two elements. A person of ordinary skill in the art may understand specific meanings of the foregoing terms in embodiments of this application according to specific situations.

In the specification, claims, and accompanying drawings of embodiments of this application, the terms “first”, “second”, “third”, “fourth”, and the like (if any) are intended to distinguish between similar objects but do not necessarily indicate a specific order or sequence.

The invention claimed is:

1. A transmission line, used for a radio frequency device, comprising a reflector, an insulation support, and a transmission structure, wherein the transmission structure comprises at least two side walls;
the transmission structure is disposed on a surface of the insulation support, an included angle between two adjacent side walls of the transmission structure is greater than zero, and different side walls of the transmission structure are located on different surfaces of the insulation support; and
at least one side wall of the transmission structure is disposed opposite to at least one surface of the reflector, and a gap exists between the at least one side wall of the transmission structure and the reflector.

2. The transmission line according to claim 1, wherein the radio frequency device is an antenna apparatus, a filter, a power splitter, a combiner, or a phase shifter.

3. A feed network, used for an antenna apparatus, comprising at least one transmission line according to claim 1.

4. An antenna apparatus, comprising a radiating element and the transmission line according to claim 1, wherein a feed network is formed through connection of at least one transmission line;
the transmission line comprises a reflector, an insulation support, and a transmission circuit, and the transmission circuit comprises a plurality of transmission structures;
both the transmission circuit and the radiating element are located on a surface of the insulation support, and the transmission circuit is electrically connected to the radiating element;
a part of the plurality of transmission structures are disposed along a first direction, and a part of the transmission structures are disposed along a second direction;
each transmission structure comprises at least two side walls, the insulation support is disposed on a first surface of the reflector, at least one side wall of each transmission structure is disposed opposite to a part of a structure of the reflector, and a gap exists between the at least one side wall of each transmission structure and the reflector; and
the first direction is a height direction of the antenna apparatus, and the second direction is a direction from a first end to a second end of the reflector.

5. The antenna apparatus according to claim 4, wherein the radiating element comprises at least one group of radiating portions; and
the at least one group of radiating portions is distributed in an array in the second direction.

6. The antenna apparatus according to claim 5, wherein the plurality of transmission structures comprise a primary transmission structure and a secondary transmission structure;
a first end of each primary transmission structure is connected to one radio frequency signal port, and a second end of each primary transmission structure is electrically connected to at least one secondary transmission structure; and
an end that is of each secondary transmission structure and that is away from a second end of the primary transmission structure is electrically connected to one radiating portion.

7. The antenna apparatus according to claim 6, wherein the primary transmission structure comprises at least a first side wall and a second side wall;
the first side wall is disposed opposite to the reflector, and a gap exists between the first side wall and the reflector;
the first side wall is electrically connected to the secondary transmission structure;
the second side wall is fixedly connected to at least a part of the first side wall, and an included angle between the second side wall and the first side wall is greater than zero;
a length of the first side wall is greater than or equal to a length of the second side wall; and
the insulation support is provided with a through hole for installing the primary transmission structure, and an end that is of the second side wall and that is away from the first side wall extends along an inner wall of the through hole in a direction away from the first side wall.

8. The antenna apparatus according to claim 7, wherein the primary transmission structure further comprises a third side wall, the third side wall is connected to the second side wall, and an end that is of the third side wall and that is away from the second side wall extends along a part of the surface of the insulation support around the through hole.

9. The antenna apparatus according to claim 7, wherein there is at least one through hole, and a part of the primary transmission structure is disposed in each through hole.

10. The antenna apparatus according to claim 6, wherein each secondary transmission structure comprises at least one transmission sub-structure;
a transmission sub-structure close to the second end of the primary transmission structure is electrically connected to the primary transmission structure;
a transmission sub-structure close to the radiating portion is electrically connected to the radiating portion; and
adjacent transmission sub-structures are connected in series to each other.

11. The antenna apparatus according to claim 10, wherein the transmission sub-structure comprises at least a fourth side wall and a fifth side wall;
the fourth side wall is disposed opposite to a part of the structure of the reflector, and a gap exists between the fourth side wall and the reflector; and
the fifth side wall is connected to the fourth side wall, and an included angle between the fourth side wall and the fifth side wall is greater than zero.

12. The antenna apparatus according to claim 11, wherein the transmission sub-structure further comprises a sixth side wall; and
the sixth side wall is connected to the fifth side wall, an included angle between the fifth side wall and the sixth side wall is greater than zero, and both the fourth side wall and the sixth side wall are located on a surface on which the fifth side wall is connected to the insulation support.

13. The antenna apparatus according to claim 10, wherein the transmission sub-structure is of a straight-line structure; or
the transmission sub-structure is of a fold-line structure, the fold-line structure is provided with at least one raised part, and the at least one raised part is spaced apart along the first direction or the second direction.

14. The antenna apparatus according to claim 13, wherein the transmission sub-structure comprises at least one first transmission sub-structure;
each first transmission sub-structure is disposed on the surface of the insulation support along the first direction, and a part of side walls of each first transmission sub-structure is disposed opposite to the part of the structure of the reflector;
a first end of each first transmission sub-structure is electrically connected to the radiating portion; and
a second end of the first transmission sub-structure is electrically connected to the second end of the primary transmission structure; or a second end of the first transmission sub-structure is electrically connected to another transmission sub-structure; or a second end of a part of the at least one first transmission sub-structure is electrically connected to the second end of the primary transmission structure, and a second end of a part of the first transmission sub-structure is electrically connected to another transmission sub-structure.

15. The antenna apparatus according to claim 14, wherein the transmission sub-structure further comprises a second transmission sub-structure;
the second transmission sub-structure is disposed on the surface of the insulation support along the second direction, and a part of side walls of the second transmission sub-structure is disposed opposite to the reflector;
the second end of the first transmission sub-structure is electrically connected to a first end of the second transmission sub-structure, and a second end of the second transmission sub-structure is electrically connected to the second end of the primary transmission structure; and
an included angle between the first transmission sub-structure and the second transmission sub-structure is greater than zero.

16. The antenna apparatus according to claim 15, wherein the first transmission sub-structure is of a straight-line structure, the second transmission sub-structure is of a fold-line structure, the fold-line structure is provided with at least one raised part, and the at least one raised part is spaced apart along the second direction.

17. The antenna apparatus according to claim 15, wherein the transmission circuit comprises a first transmission circuit and a second transmission circuit;
the first transmission circuit comprises a first primary transmission structure and at least one secondary transmission structure, a first end of the first primary transmission structure is connected to a first radio frequency signal port, and a second end of the first primary transmission structure is electrically connected to the at least one secondary transmission structure; and
the second transmission circuit comprises a second primary transmission structure and at least one secondary transmission structure, a first end of the second primary transmission structure is connected to a second radio frequency signal port, and a second end of the second primary transmission structure is electrically connected to the at least one secondary transmission structure.

18. The antenna apparatus according to claim 17, wherein the reflector comprises a bottom plate and a radiating plate;
the bottom plate is located at a bottom end of the reflector, the radiating plate is fastened to a surface of the bottom plate, and the first surface of the reflector is a surface on which the bottom plate is connected to the radiating plate;
in the first direction, an end of the radiating plate is located on the first surface, and another end extends in a direction away from the first surface;
in the second direction, the radiating plate extends from a first end of the reflector to a second end of the reflector, and the radiating plate is located between a third end and a fourth end of the bottom plate; and
an included angle between the radiating plate and the bottom plate is a first included angle, and the first included angle is greater than zero.

19. The antenna apparatus according to claim 18, wherein the insulation support comprises a base and a support wall;
the base is disposed opposite to the bottom plate, and in the first direction, an end of the support wall is located on a surface that is of the base and that is away from the bottom plate, and another end extends in a direction away from the base;
at least one support wall is spaced apart along the second direction on the surface that is of the base and that is away from the bottom plate;
the support wall is disposed along a third direction, a first end of the support wall is close to the third end of the bottom plate, and a second end of the support wall is close to the fourth end of the bottom plate;
an included angle between the support wall and the base is a second included angle, and the second included angle is greater than zero; and
the third direction is a direction from the third end to the fourth end of the reflector.

20. The antenna apparatus according to claim 19, wherein the first transmission sub-structure is disposed on a surface of the support wall, a fourth side wall of the first transmission sub-structure is disposed opposite to the radiating plate, the first end of the first transmission sub-structure is located at an end that is of the support wall and that is close to the base, and the second end of the first transmission sub-structure extends along the surface of the support wall in the direction away from the base;
an included angle between the first transmission sub-structure and a plane on which the base is located is greater than zero; and
each first transmission sub-structure corresponds to one radiating portion, and an end that is of the first transmission sub-structure and that is away from the base is electrically connected to the radiating portion.
